(19) United States
(12) Patent Application Publication
(10) Pub. No.: US 2025/0193849 A1
(43) Pub. Date: Jun. 12, 2025

(54) CHANNEL-BASED RESOURCE SELECTION FOR FEEDBACK MESSAGES

(71) Applicant: QUALCOMM Incorporated, San Diego, CA (US)

(72) Inventors: Peer BERGER, Hod Hasharon (IL); Shay LANDIS, Hod Hasharon (IL); Jacob PICK, Mevaseret Zion (IL); Tomer GEVA, Kiryat Ono (IL); Ran BERLINER, Kfar Aviv (IL)

(21) Appl. No.: 18/531,110

(22) Filed: Dec. 6, 2023

(51) Int. Cl. H04W 72/04; H04W 72/50

(52) U.S. Cl. CPC H04W 72/04; H04W 72/535

(57) ABSTRACT

Methods, systems, and devices for wireless communications are described. In some examples, a user equipment (UE) may receive a message from a network entity that indicates a channel-based resource selection procedure for one or more feedback messages. The channel-based resource selection procedure may be based on one or more channel estimates. The channel-based resource selection procedure may include a resource selection rule, a neural network (NN) algorithm, an explicit resource allocation, or a combination thereof. The UE may receive a downlink message via a downlink channel. The UE may transmit, on a set of resources associated with an uplink channel, one or more feedback messages that indicate whether the downlink message was successfully decoded. The set of resources may be based on the one or more channel estimates in accordance with the channel-based resource selection procedure.

### FIELD OF TECHNOLOGY

The following relates to wireless communications, including channel-based resource selection for feedback messages.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel-based resource selection for feedback messages. For example, the described techniques may enable a user equipment (UE) to receive a message (e.g., from a network entity) that indicates a channel-based resource selection procedure for one or more feedback messages. The channel-based resource selection procedure may be based on one or more channel estimates (e.g., channel measurements, channel quality metrics). The channel-based resource selection procedure may include a resource selection rule (e.g., algorithm, one or more parameters associated with a resource selection rule), a neural network (NN) algorithm (e.g., NN coefficients), an explicit resource allocation, or any combination thereof. The UE may receive a downlink message via a downlink channel from a network entity. The UE may transmit one or more feedback messages that indicate whether the downlink message was successfully decoded (e.g., successfully received). The UE may transmit the one or more feedback messages on a set of resources (e.g., of an uplink channel) that are based on the one or more channel estimates and determined (e.g., selected) in accordance with the channel-based resource selection procedure.

A method for wireless communications by a UE is described. The method may include receiving a message indicating a channel-based resource selection procedure for a feedback message, where the channel-based resource selection procedure is based on one or more channel estimates, receiving a downlink message via a downlink channel, and transmitting, via a set of resources associated with an uplink channel, the feedback message indicating whether the downlink message was successfully decoded, where the set of resources is based on the one or more channel estimates and in accordance with the channel-based resource selection procedure.

A UE for wireless communications is described. The UE may include one or more memories storing processor executable code, and one or more processors coupled with the one or more memories. The one or more processors may individually or collectively operable to execute the code to cause the UE to receive a message indicating a channel-based resource selection procedure for a feedback message, where the channel-based resource selection procedure is based on one or more channel estimates, receive a downlink message via a downlink channel, and transmit, via a set of resources associated with an uplink channel, the feedback message indicating whether the downlink message was successfully decoded, where the set of resources is based on the one or more channel estimates and in accordance with the channel-based resource selection procedure.

Another UE for wireless communications is described. The UE may include means for receiving a message indicating a channel-based resource selection procedure for a feedback message, where the channel-based resource selection procedure is based on one or more channel estimates, means for receiving a downlink message via a downlink channel, and means for transmitting, via a set of resources associated with an uplink channel, the feedback message indicating whether the downlink message was successfully decoded, where the set of resources is based on the one or more channel estimates and in accordance with the channel-based resource selection procedure.

A non-transitory computer-readable medium storing code for wireless communications is described. The code may include instructions executable by one or more processors to receive a message indicating a channel-based resource selection procedure for a feedback message, where the channel-based resource selection procedure is based on one or more channel estimates, receive a downlink message via a downlink channel, and transmit, via a set of resources associated with an uplink channel, the feedback message indicating whether the downlink message was successfully decoded, where the set of resources is based on the one or more channel estimates and in accordance with the channel-based resource selection procedure.

Some examples of the method, user equipment (UEs), and non-transitory computer-readable medium described herein may further include operations, features, means, or instructions for transmitting a capability message indicating one or more capabilities associated with the channel-based resource selection procedure, where the channel-based resource selection procedure indicated via the message may be based on the one or more capabilities.

Some examples of the method, user equipment (UEs), and non-transitory computer-readable medium described herein may further include operations, features, means, or instructions for receiving, via the message, an indication of a resource selection rule of a set of multiple resource selection rules configured at the UE, where the channel-based resource selection procedure corresponds to the resource selection rule and determining the set of resources associated with the uplink channel in accordance with the resource selection rule and the one or more channel estimates.

Some examples of the method, UEs, and non-transitory computer-readable medium described herein may further include operations, features, means, or instructions for receiving a control message that activates or deactivates the resource selection rule, where the control message may be received via a medium access control-control element (MAC-CE), a downlink control information (DCI) message, or both.

Some examples of the method, UEs, and non-transitory computer-readable medium described herein may further include operations, features, means, or instructions for receiving, via the message, an indication of one or more parameters associated with a resource selection rule, where the channel-based resource selection procedure corresponds to the resource selection rule and determining the set of resources associated with the uplink channel using the one or more parameters and the resource selection rule.

In some examples of the method, UEs, and non-transitory computer-readable medium described herein, the one or more parameters include one or more thresholds associated with the resource selection rule.

Some examples of the method, UEs, and non-transitory computer-readable medium described herein may further include operations, features, means, or instructions for receiving, via the message, an indication of one or more coefficients associated with a NN algorithm, where the channel-based resource selection procedure corresponds to the NN algorithm and determining the set of resources associated with the uplink channel using the one or more coefficients associated with the NN algorithm.

Some examples of the method, UEs, and non-transitory computer-readable medium described herein may further include operations, features, means, or instructions for transmitting a second message indicating one or more second coefficients for the NN algorithm based on the indication of the one or more coefficients, at least one of the one or more second coefficients different from the one or more coefficients.

Some examples of the method, UEs, and non-transitory computer-readable medium described herein may further include operations, features, means, or instructions for receiving, via the message, an indication of an allocation of the set of resources associated with the uplink channel, where the channel-based resource selection procedure includes determining the set of resources in accordance with the allocation.

Some examples of the method, UEs, and non-transitory computer-readable medium described herein may further include operations, features, means, or instructions for receiving a control message that activates or deactivates the allocation for the set of resources, where the control message may be received via a MAC-CE, a DCI message, or both.

In some examples of the method, UEs, and non-transitory computer-readable medium described herein, the channel-based resource selection procedure may be further based on a quantity of UEs, a format of the feedback message, a payload size of the feedback message, an allocation configuration, a slot structure, or any combination thereof.

Some examples of the method, UEs, and non-transitory computer-readable medium described herein may further include operations, features, means, or instructions for receiving, via the message, an indication of a set of multiple channel-based resource selection procedures including the channel-based resource selection procedure, where the message indicates the channel-based resource selection procedure based on an index included in the message that corresponds to the channel-based resource selection procedure.

Some examples of the method, UEs, and non-transitory computer-readable medium described herein may further include operations, features, means, or instructions for receiving an indication of a bandwidth allocation for the UE, where the set of resources may be based on the bandwidth allocation and in accordance with the channel-based resource selection procedure.

A method for wireless communications by a network entity is described. The method may include outputting a message indicating a channel-based resource selection procedure for a feedback message, where the channel-based resource selection procedure is based on one or more channel estimates, outputting a downlink message via a downlink channel, and obtaining, via a set of resources associated with an uplink channel, the feedback message indicating whether the downlink message was successfully decoded, where the set of resources are based on the channel-based resource selection procedure.

A network entity for wireless communications is described. The network entity may include one or more memories storing processor executable code, and one or more processors coupled with the one or more memories. The one or more processors may individually or collectively operable to execute the code to cause the network entity to output a message indicating a channel-based resource selection procedure for a feedback message, where the channel-based resource selection procedure is based on one or more channel estimates, output a downlink message via a downlink channel, and obtain, via a set of resources associated with an uplink channel, the feedback message indicating whether the downlink message was successfully decoded, where the set of resources are based on the channel-based resource selection procedure.

Another network entity for wireless communications is described. The network entity may include means for outputting a message indicating a channel-based resource selection procedure for a feedback message, where the channel-based resource selection procedure is based on one or more channel estimates, means for outputting a downlink message via a downlink channel, and means for obtaining, via a set of resources associated with an uplink channel, the feedback message indicating whether the downlink message was successfully decoded, where the set of resources are based on the channel-based resource selection procedure.

A non-transitory computer-readable medium storing code for wireless communications is described. The code may include instructions executable by one or more processors to output a message indicating a channel-based resource selection procedure for a feedback message, where the channel-based resource selection procedure is based on one or more channel estimates, output a downlink message via a downlink channel, and obtain, via a set of resources associated with an uplink channel, the feedback message indicating whether the downlink message was successfully decoded, where the set of resources are based on the channel-based resource selection procedure.

Some examples of the method, network entities, and non-transitory computer-readable medium described herein may further include operations, features, means, or instructions for obtaining a capability message indicating one or more capabilities of a UE associated with the channel-based resource selection procedure, where the channel-based resource selection procedure indicated via the message may be based on the one or more capabilities.

Some examples of the method, network entities, and non-transitory computer-readable medium described herein may further include operations, features, means, or instructions for outputting, via the message, an indication of a resource selection rule of a set of multiple resource selection rules configured at the network entity, where the channel-based resource selection procedure corresponds to the resource selection rule, and where the set of resources associated with the uplink channel may be based on the resource selection rule and the one or more channel estimates.

Some examples of the method, network entities, and non-transitory computer-readable medium described herein may further include operations, features, means, or instructions for outputting a control message that activates or deactivates the resource selection rule, where the control message may be received via a MAC-CE, a DCI message, or both.

Some examples of the method, network entities, and non-transitory computer-readable medium described herein may further include operations, features, means, or instructions for outputting, via the message, an indication of one or more parameters associated with a resource selection rule, where the channel-based resource selection procedure corresponds to the resource selection rule, where the set of resources associated with the uplink channel may be based on the one or more parameters and the resource selection rule.

In some examples of the method, network entities, and non-transitory computer-readable medium described herein, the one or more parameters include one or more thresholds associated with the resource selection rule.

Some examples of the method, network entities, and non-transitory computer-readable medium described herein may further include operations, features, means, or instructions for outputting, via the message, an indication of one or more coefficients associated with a NN algorithm, where the channel-based resource selection procedure corresponds to the NN algorithm, where the set of resources associated with the uplink channel may be based on the one or more coefficients associated with the NN algorithm.

Some examples of the method, network entities, and non-transitory computer-readable medium described herein may further include operations, features, means, or instructions for obtaining a second message indicating one or more second coefficients for the NN algorithm based on the indication of the one or more coefficients, at least one of the one or more second coefficients different from the one or more coefficients.

Some examples of the method, network entities, and non-transitory computer-readable medium described herein may further include operations, features, means, or instructions for outputting, via the message, an indication of an allocation of the set of resources associated with the uplink channel, where the channel-based resource selection procedure includes determining the set of resources in accordance with the allocation.

Some examples of the method, network entities, and non-transitory computer-readable medium described herein may further include operations, features, means, or instructions for outputting a control message that activates or deactivates the allocation for the set of resources, where the control message may be received via a MAC-CE, a DCI message, or both.

In some examples of the method, network entities, and non-transitory computer-readable medium described herein, the channel-based resource selection procedure may be further based on a quantity of UEs, a format of the feedback message, a payload size of the feedback message, an allocation configuration, a slot structure, or any combination thereof.

Some examples of the method, network entities, and non-transitory computer-readable medium described herein may further include operations, features, means, or instructions for outputting, via the message, an indication of a set of multiple channel-based resource selection procedures including the channel-based resource selection procedure, where the message indicates the channel-based resource selection procedure based on an index included in the message that corresponds to the channel-based resource selection procedure.

Some examples of the method, network entities, and non-transitory computer-readable medium described herein may further include operations, features, means, or instructions for outputting an indication of a bandwidth allocation for a UE, where the set of resources may be determined based on the bandwidth allocation and in accordance with the channel-based resource selection procedure.

### BRIEF DESCRIPTION OF THE DRAWINGS

FIG. 1 shows an example of a wireless communications system that supports channel-based resource selection for feedback messages in accordance with one or more aspects of the present disclosure.

FIG. 2 shows an example of a wireless communications system that supports channel-based resource selection for feedback messages in accordance with one or more aspects of the present disclosure.

FIG. 3 shows an example of a resource configuration that supports channel-based resource selection for feedback messages in accordance with one or more aspects of the present disclosure.

FIG. 4 shows an example of a resource configuration that supports channel-based resource selection for feedback messages in accordance with one or more aspects of the present disclosure.

FIG. 5 shows an example of a process flow that supports channel-based resource selection for feedback messages in accordance with one or more aspects of the present disclosure.

FIGS. 6 and 7 show block diagrams of devices that support channel-based resource selection for feedback messages in accordance with one or more aspects of the present disclosure.

FIG. 8 shows a block diagram of a communications manager that supports channel-based resource selection for feedback messages in accordance with one or more aspects of the present disclosure.

FIG. 9 shows a diagram of a system including a device that supports channel-based resource selection for feedback messages in accordance with one or more aspects of the present disclosure.

FIGS. 10 and 11 show block diagrams of devices that support channel-based resource selection for feedback messages in accordance with one or more aspects of the present disclosure.

FIG. 12 shows a block diagram of a communications manager that supports channel-based resource selection for feedback messages in accordance with one or more aspects of the present disclosure.

FIG. 13 shows a diagram of a system including a device that supports channel-based resource selection for feedback messages in accordance with one or more aspects of the present disclosure.

FIGS. 14 through 19 show flowcharts illustrating methods that support channel-based resource selection for feedback messages in accordance with one or more aspects of the present disclosure.

### DETAILED DESCRIPTION

In some wireless communications systems, a user equipment (UE) may transmit one or more feedback messages to a network entity (e.g., an acknowledgment (ACK) feedback message, a negative acknowledgment (NACK) feedback message, an uplink control information (UCI) message) to indicate whether the UE received (e.g., decoded) a downlink message successfully or unsuccessfully. In some cases, the one or more feedback messages may support mechanisms (e.g., such as message retransmissions) to recover from unsuccessful downlink transmissions and may improve communication reliability. For instance, the UE may receive a downlink message via the downlink channel and may transmit a corresponding feedback message to the network entity via an uplink channel that indicates whether the UE successfully decoded the downlink message.

In some cases, the network entity and the UE may determine (e.g., select, identify, compute) a resource allocation (e.g., of time and frequency resources) for a feedback message based on a resource selection procedure (e.g., based on a radio resource control (RRC) configuration and a downlink control information (DCI) message). However, some resource selection procedures may not account for channel characteristics (e.g., a channel quality, a channel response, a channel estimation). Such resource selection procedures may therefore allocate resources that are associated with a relatively poor channel quality, such as frequency locations associated with channel fading. Transmitting a feedback message on such resources may reduce communication quality between the UE and the network entity. For instance, using resources that are associated with a relatively poor channel quality may reduce a likelihood that the feedback messages are successfully communicated between the UE and the network entity. In some cases, unsuccessful feedback messages may result in excess retransmission signaling, increased energy consumption, increased latency, and reduced system capacity, among other effects.

Various aspects described herein relate generally to improved resource selection procedures for one or more feedback messages and more particularly to techniques that enable channel-based resources selection procedures, which may account for channel characteristics as part of a resource allocation (e.g., a “channel-aware” resource selection procedure). Some aspects more specifically relate to an indication (e.g., from a network entity to a UE) of a channel-based resource selection procedure that is based on one or more channel estimates (e.g., channel measurements, channel responses, channel quality metrics, estimates of an uplink channel, a downlink channel, or both). The channel-based resource selection procedure may include defined resource selection rules, neural network (NN) algorithms, and allocation indications, among other examples.

In some examples, a UE and a network entity may be configured with one or more channel-based resource selection rules (e.g., a set of configured rules, algorithms), and the network entity may indicate which rule the UE is to use for feedback message resource selection. Additionally, or alternatively, the network entity may indicate one or more thresholds associated with a resource selection rule. In some examples, a network entity may configure a neural network (NN) algorithm that accounts for one or more channel estimates. For example, the network entity may transmit an indication of one or more coefficients for an NN algorithm, which the UE may use to determine resources for feedback message signaling that are based on a channel. Additionally, or alternatively, the network entity may transmit an explicit allocation of resources for the UE to use for feedback message signaling. Such techniques may enable a UE and a network entity to appropriately account for variations in a channel (e.g., an uplink channel) that is used to communicate one or more feedback messages.

Particular aspects of the subject matter described in this disclosure may be implemented to realize one or more of the following potential advantages. In some examples, by communicating one or more messages that indicate a channel-based resource selection procedures for one or more feedback messages, the described techniques may increase reliability of feedback signaling mechanisms in a wireless communications system. For example, by using channel-based resource selection procedures, a UE and a network entity may communicate one or more feedback message using relatively higher quality resources (e.g., in accordance with the channel-based resource selection procedure), thus increasing a likelihood that one or more feedback messages are successfully communicated. Accordingly, by transmitting one or more feedback messages based on the channel-based resource selection procedure, relatively fewer feedback messages may fail, which may reduce retransmission signaling overhead and energy consumption. Additionally, the reduced signaling overhead resulting from the channel-based resource selection procedures may support relatively more efficient utilization of communication resources, thus increasing system capacity and throughput of a wireless communications system and the devices therein.

Aspects of the disclosure are initially described in the context of wireless communications systems. Aspects of the disclosure are further illustrated by and described with reference to resource configurations, process flows, apparatus diagrams, system diagrams, and flowcharts that relate to channel-based resource selection for feedback messages.

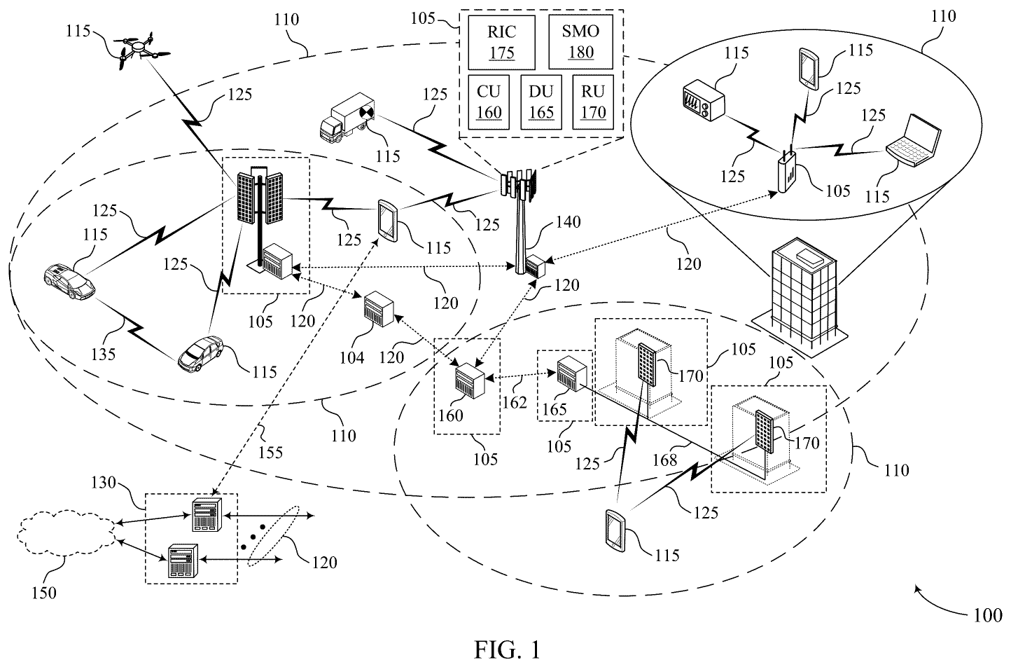

FIG. 1 shows an example of a wireless communications system 100 that supports channel-based resource selection for feedback messages in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other cases, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support channel-based resource selection for feedback messages as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Devices of the wireless communications system 100 may utilize one or more techniques for resource allocation (e.g., dynamic resource allocation by DCI sent via a physical downlink control channel (PDCCH)). In some cases, the techniques may include an explicit resource allocation scheme (e.g., which may not be conventionally supported for a physical uplink control channel (PUCCH)). For instance, resources may be allocated using “start and length” compressed into a single word (e.g., a resource indication value (RIV) or a start and length indicator (SLIV), used for consecutive allocation). Additionally, or alternatively, resources may be allocated using a bit vector (e.g., used for distributed allocation). Alternatively, the techniques may include an implicit resource allocation. For instance, a resource may be selected by a network entity 105 (e.g., a gNB) from a configured list of resources, in which a chosen resource index may be conveyed by a DCI field. The index value may be jointly derived from a designated DCI field and other inputs (e.g., triggering DCI location).

Explicit resource allocation and implicit resource allocation may be associated with different attributes. For instance, an explicit resource allocation may not be associated with resource limitations (e.g., may be relatively more optimal), while choices for an implicit resource allocation may be associated with a (e.g., limited) configured list and may utilize joint inputs for index derivation (e.g., triggering DCI frequency location along with DCI PUCCH resource indicator (PRI) field), which may prevent optimal selection of an uplink resource. Moreover, an implicit resource allocation may utilize a relatively small DCI bit field size (e.g., that may be dictated by a configured list size), while an explicit resource allocation may utilize a relatively large DCI bit field size (e.g., for covering various possible allocations). Additionally, an explicit resource allocation may be associated with relatively low (e.g., or no) signaling overhead (e.g., RRC overhead), while an implicit resource allocation may be associated with relatively higher signaling overhead (e.g., ongoing list maintenance to be coherent with signal variations).

In some cases, the wireless communications system 100 may support resource allocation for uplink resources (e.g., PUCCH resource allocation, UCI resource allocation). In some cases, a UCI message may be associated with two bits or less (e.g., UCI≤2 bits). In some examples, the allocation may be an implicit PUCCH resource allocation. A PUCCH resource may be selected by a network entity 105 (e.g., a gNB) from a preconfigured resource list. Each entry in the list may include time symbols, start and length, and a resource block (RB) location (e.g., a single RB location). The selected resource index may be jointly calculated using a PRI field in a triggering DCI and the DCI location. For instance, for a first set of PUCCH resources and when a size, R_{PUCCH}, of resourceList is larger than eight, when a UE 115 provides HARQ-ACK information in a PUCCH transmission in response to detecting a last DCI format in a PDCCH reception, among DCI formation with a value of the physical downlink shared channel (PDSCH)-to HARQ feedback timing indicator field, if present, or a value of dl-DataToUL-ACK, or dl-DataToUL-ACK, or dl-DataToUL-ACK-DCI-1-2, indicating a same slot for the PUCCH transmission, the UE 115 may determine a PUCCH resource with index r_{PUCCH}, 0≤r_{PUCCH}≤R_{PUCCH}−1, as Equation 1.

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ \\ if {Δ}_{PRI} < {R}_{PUCCH} mod 8 \\ ⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ + \\ {R}_{PUCCH} mod 8 if {Δ}_{PRI} < {R}_{PUCCH} mod 8\end{matrix} \qquad Equation 1$$

In Equation 1, N_{CCE,p} may be a quantity of CCEs in CORESET p of the PDCCH reception for the DCI format, n_{CCE,p} may be an index of a first CCE for the PDCCH reception, and Δ_{PRI} may be a value of the PUCCH resource indicator field in the DCI format. If a DCI format does not include a PUCCH resource indicator field, Δ_{PRI} may be equal to 0.

In such cases of implicit PUCCH resource allocation, resource selection techniques may use a joint uplink-downlink resource selection from a finite pre-configured set, which may be relatively less ideal (e.g., less optimal) for both downlink and uplink channel resource location. Additionally, for maintaining a joint uplink-downlink resource configuration and association, a network entity 105 may continually update an uplink channel configuration (e.g., a UE RRC PUCCH configuration) according to the channel variations, which may introduce over the air (OTA) signaling overhead and ongoing computation effort.

In some cases, a UE 115 may transmit one or more feedback messages to a network entity 105 (e.g., an ACK/NACK feedback messages, UCI feedback messages, HARQ messages) to indicate whether the UE 115 decoded a message (e.g., a downlink message from the network entity 105) successfully or unsuccessfully. For instance, the UE 115 may receive a downlink message via a downlink channel and may transmit (e.g., in response to the downlink message) one or more feedback messages to the network entity 105 via an uplink channel. However, in some cases, the UE 115 and the network entity 105 may utilize a resource selection procedure for a feedback message that may not account for channel characteristics (e.g., channel quality, channel response). Accordingly, such resource selection procedures may allocate resources that are associated with a relatively poor channel quality (e.g., frequency locations associated with channel fading) resulting in excess retransmission of downlink messages, increased energy consumption, increased latency, and reduced system capacity, among other effects in the wireless communications system 100.

In accordance with aspects described herein, a UE 115 and a network entity 105 may utilize channel-based (e.g., channel-aware) resource selection procedures for communication of one or more feedback messages (e.g., ACK/NACK resource selection). The channel-based resource selection procedures may be based on one or more estimates (e.g., measurements, calculations, metrics) of a channel (e.g., an uplink channel, a downlink channel, or both). For instance, a UE 115 may receive a message from a network entity 105 that may indicate a channel-based resource selection procedure (e.g., a resource selection algorithm, an NN algorithm) for the UE 115 to use for resource allocation, or may indicate one or more parameters (e.g., one or more thresholds, one or more coefficients) associated with the channel-based resource selection procedure, or both. Additionally, or alternatively, the message may indicate a specific allocation of resources (e.g., PUCCH resources) for the UE 115 to use to transmit the one or more feedback messages. Accordingly, the wireless communications system 100 may support improved communication reliability, increased system capacity, and improved coordination between devices.

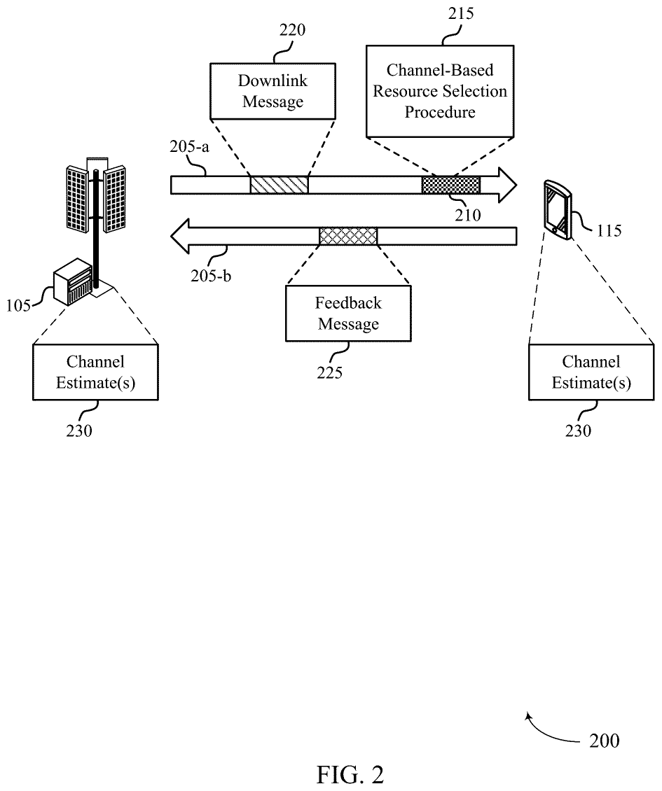

FIG. 2 shows an example of a wireless communications system 200 that supports channel-based resource selection for feedback messages in accordance with one or more aspects of the present disclosure. The wireless communications system 200 may implement, or be implemented by, aspects of the wireless communications system 100 as described with reference to FIG. 1. For example, the wireless communications system 200 may include a network entity 105 and a UE 115. The network entity 105 may communicate with the UE 115 via a communication link 205-a and a communication link 205-b. The communication link 205-a and the communication link 205-b may be examples of or include downlink communication interfaces, uplink communication interfaces, or other communication interfaces as described herein. Although a network entity 105 and a UE 115 are shown as example devices of the wireless communications system 200, the techniques described herein may be applied by any wireless or network device (e.g., including with reference to other devices described in FIG. 1). In some examples, the network entity 105 and the UE 115 may utilize signaling mechanisms (e.g., one or more messages 210, one or more downlink messages 220, one or more feedback messages 225, and/or other signaling) to enable resource selection procedures that account for one or more channel estimates 230.

The wireless communications system 200 may support feedback mechanisms to improve communications between the network entity 105 and the UE 115. For instance, the ULE 115 may transmit one or more feedback messages (e.g., UE ACK/NACK feedback) via a UCI. The UCI may be transmitted (e.g., conveyed) via the communication link 205-b (e.g., a PUCCH or a physical uplink shared channel (PUSCH) channel). A resource allocation (e.g., an uplink allocation in both time and frequency, an allocation for the UCI) may be determined by an RRC configuration and a DCI in a resource selection procedure. However, some resource selection procedures for a UCI (e.g., a feedback message 225) may not consider channel information (e.g., channel knowledge, one or more channel estimates 230 performed by the network entity 105, or the UE 115, or both), thus a likelihood of successfully decoding the UCI (e.g., by the network entity 105) may be relatively reduced (e.g., suboptimal). In some cases, if the network entity 105 fails to receive a feedback message 225 from the UE 115 (e.g., an ACK message from the UE 115), the network entity 105 may perform redundant retransmissions of a message (e.g., a downlink message 220) thus utilizing (e.g., wasting) additional resources (e.g., cell resources) and reducing both a throughput of a UE 115 and system capacity (e.g., cell capacity).

In some cases, the feedback message 225 may be transmitted via UCI over the communication link 205-b, which may be a PUCCH channel or a PUSCH channel (e.g., in case of a collision with a PUSCH message, a combined PUSCH message including control information). A resource allocation (e.g., UCI allocation) in a frequency domain may be determined by a resource selection procedure that is based on an RRC configuration, and the resource allocation in a time domain may be determined by the network entity 105 in a control message (e.g., a DCI message, as part of the resource selection procedure). The resource selection procedure may be relatively complex but may be deterministic. That is, both the network entity 105 and the UE 115 may arrive at a same resource allocation conclusion for the feedback message 225 (e.g., there may be no room for discretion by the network entity 105 or the UE 115).

A payload of the feedback message 225 (e.g., the UCI payload) may be relatively short (e.g., including a relatively small quantity of bits), and the allocation size occupied by the feedback message 225 may also be relatively small. As such, the feedback message 225 may be relatively more sensitive to fading effects (e.g., channel fading, signal attenuation, signal degradation, relatively poor channel quality). Accordingly, a specific resource allocation may be relatively more significant for relatively smaller the allocation sizes. Some PUCCH messages may be associated with a narrow band. For example, a feedback message 225 may be a HARQ-only PUCCH (e.g., for ACK/NACK a quantity of information bits may be one or two) and may use a format (e.g., a PUCCH format 0 or a PUCCH format 1) that occupies a single RB (e.g., a relatively small resource allocation). In another example, a quantity of bits of a feedback message 225 (e.g., a UCI message) may be more than two bits, and the feedback message 225 may use a format (e.g., a PUCCH format 4) that occupies a single RB. Alternatively, the feedback message 225 may use a format (e.g., PUCCH format 2, PUCCH format 3) that occupies a quantity of RBs (e.g., RB range may be between 1 and 16) that is based on a payload size of the feedback message 225, a used modulation and target code rate for the feedback message 225, or both.

In some cases, the feedback message 225 may be associated with a format of an uplink channel (e.g., a PUCCH format), and the format may be associated with an allocation size. For example, a first format (e.g., format 0) and a second format (e.g., format 1) may be associated with one RB (e.g., exclusively for ACK/NACK). A third format (e.g., format 2) and a fourth format (e.g., format 3) may be associated with one or more RBs (e.g., up to 16 RBs, for channel state information (CSI) and ACK/NACK). A fifth format (e.g., format 4) may also be associated with one RB. Thus, in many cases, the payload for the feedback message 225 may be relatively short and may thus be significantly affected by channel characteristics (e.g., fading portions of a channel spectrum). Additionally, some resource selection procedures may not consider one or more channel estimates 230 (e.g., channel knowledge, a decoding probability by the network entity 105 may be suboptimal). Accordingly, to improve reliability of a feedback message 225 (e.g., improve the probability that the feedback message 225 is received by the network entity 105, to avoid fading), resource selection procedures may be improved to account for one or more channel estimates 230.

In accordance with techniques described herein, the wireless communications system 200 may support one or more resource selection procedures for a feedback message 225 (e.g., resource selection for ACK/NACK feedback of the UE 115) that account for the one or more channel estimates 230 (e.g., the feedback message 225 may be channel aware). For example, the UE 115, or the network entity 105, or both may perform one or more channel estimates 230 to determine (e.g., measure, identify, calculate) one or more characteristics of a channel (e.g., a communication link 205-a, a communication link 205-b, or both). The one or more channel estimates 230 may include channel quality metrics, channel responses, interference estimations, CSI, channel signal to noise ratio (SNR), or other characteristics used to determine (e.g., measure, quantify, report, calculate) a quality of a channel. In some cases, one or more channel estimates 230 that are performed for a downlink channel (e.g., a communication link 205-a) may also apply for a corresponding uplink channel (e.g., a communication link 205-b) based on a channel reciprocity property (e.g., inherent in time division duplex (TDD)). Accordingly, the network entity 105 and the UE 115 may utilize the channel reciprocity to enable a resource selection procedure (e.g., a channel-based resource selection procedure) to account for the channel (e.g., one or more channel estimates 230).

In some examples, the network entity 105 may configure the UE 115 to apply a channel-based (e.g., channel aware) resource selection procedure for the feedback message 225 (e.g., an ACK/NACK resource selection). The network entity 105 may transmit one or more messages 210 to the UE 115 that indicate a channel-based resource selection procedure 215 for the feedback message 225. The channel-based resource selection procedure 215 may be based on the one or more channel estimates 230 (e.g., performed by the network entity 105, the UE 115, or both). The network entity 105 may transmit a downlink message 220 to the UE 115. Accordingly, the UE 115 may determine (e.g., select) a set of resources associated with an uplink channel (e.g., the communication link 205-b) for the feedback message 225 based at least in part on the one or more channel estimates 230 and in accordance with the channel-based resource selection procedure 215. That is, the UE 115 may be enabled to perform a channel-based resource selection procedure 215 based at least in part on receiving the one or more messages 210.

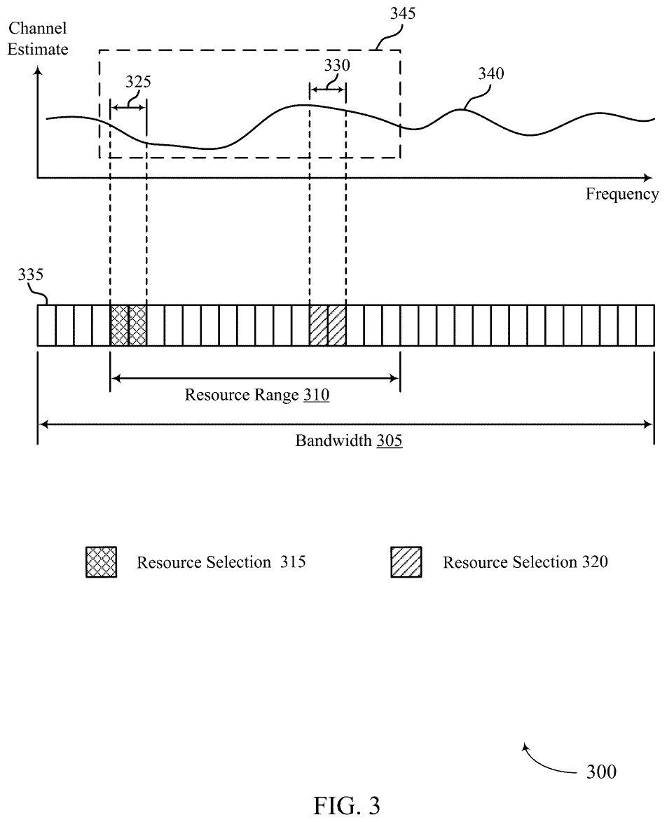

The UE 115 may transmit the feedback message 225 based on the channel-based resource selection procedure 215, and the feedback message 225 may indicate that the downlink message 220 was successfully decoded (e.g., received) or that the downlink message 220 was unsuccessfully decoded. The one or more messages 210 and the channel-based resource selection procedure 215 are described in greater detail herein, including with reference to FIGS. 3 through 5. Such techniques may improve a likelihood (e.g., a decoding probability) that the feedback message 225 (e.g., ACK/NACK feedback) is successfully received by the network entity 105. Thus, the wireless communications system 200 may support more efficient resource utilization, increased capacity (e.g., cell capacity), and throughput of the UE 115, among other benefits.

FIG. 3 shows an example of a resource configuration 300 that supports channel-based resource selection for feedback messages in accordance with one or more aspects of the present disclosure. The resource configuration 300 may illustrate a mapping between multiple frequency resources 335 (e.g., RBs) of a bandwidth 305 and a curve 340. The curve 340 may represent one or more channel estimates (e.g., one or more channel estimates 230, channel SNR values) of a channel between a UE 115 and a network entity 105 (e.g., estimates of a channel associated with the bandwidth 305, a downlink channel, an uplink channel). Relatively higher points on the curve 340 may correspond to a relatively higher channel quality (e.g., relatively higher channel SNR). For example, a first resource selection 315 corresponding to a range 325 of the curve 340 may be associated with a relatively lower channel quality (e.g., relatively more susceptible to fading) than a second resource selection 320 corresponding to a range 330 of the curve 340.

In some cases, a wireless communication system may support implicit resource allocation for uplink messages (e.g., PUCCH resource allocation), and uplink resources may be selected (e.g., by a network entity 105) from a preconfigured resource list. Each entry in the list may include a time symbol start and length and an RB start and length (e.g., M_{RB}={1.16}). A PUCCH resource index may be conveyed in a PRI field in a triggering DCI according to Table 1, which may include a mapping of PUCCH resource indication field values to a PUCCH resource in a PUCCH resource set (e.g., with a maximum of eight PUCCH resources).

TABLE 1

| PUCCH resource indicator | | | |
|---|---|---|---|
| 1 bit | 2 bits | 3 bits | PUCCH resource |
| ‘0’ | ‘00’ | ‘000’ | 1^{st} PUCCH resource provided by |
| | | | pucch-ResourceId obtained from the |
| | | | 1^{st} value of resourceList |
| ‘1’ | ‘01’ | ‘001’ | 2^{nd} PUCCH resource provided by |
| | | | pucch-ResourceId obtained from the |
| | | | 2^{nd} value of resourceList |
| | ‘10’ | ‘010’ | 3^{rd} PUCCH resource provided by |
| | | | pucch-ResourceId obtained from the |
| | | | 3^{rd} value of resourceList |
| | ‘11’ | ‘011’ | 4^{th} PUCCH resource provided by |
| | | | pucch-ResourceId obtained from the |
| | | | 4^{th} value of resourceList |
| | | ‘100’ | 5^{th} PUCCH resource provided by |
| | | | pucch-ResourceId obtained from the |
| | | | 5^{th} value of resourceList |
| | | ‘101’ | 6^{th} PUCCH resource provided by |
| | | | pucch-ResourceId obtained from the |
| | | | 6^{th} value of resourceList |
| | | ‘110’ | 7^{th} PUCCH resource provided by |
| | | | pucch-ResourceId obtained from the |
| | | | 7^{th} value of resourceList |
| | | ‘111’ | 8^{th} PUCCH resource provided by |
| | | | pucch-ResourceId obtained from the |
| | | | 8^{th} value of resourceList |

However, some resource selection procedures may not account for a channel estimate (e.g., may not consider the channel estimated by the curve 340). For instance, a UE 115 may be configured with a resource range 310 (e.g., M_{RB}, including 16 frequency resources 335 or RBs) that is allocated for an uplink feedback message (e.g., a PUCCH message, a UCI). Some resource selection procedures may produce a first resource selection 315 that is a start of the resource range 310 (e.g., an RB start), while an actual quantity of frequency resources 335 (e.g., RBs) used for the PUCCH transmission (e.g., a feedback message) may be a threshold length (e.g., minimum length) for achieving a configured PUCCH code rate (e.g., a range 325, denoted as M_{RB,min}^{PUCCH}). In such cases, if a quantity of used frequency resources 335 is relatively smaller than a configured resource range 310 (e.g., RB length, M_{RB,min}^{<M}_{RB}) and an uplink channel of a selected PUCCH resource span (e.g., a channel portion 345 corresponding to the resource range 310) is varied (e.g., is associated with various values of a channel estimate), there may be an opportunity to select a frequency allocation associated with improved channel quality (e.g., which may not be the first RBs of the resource range 310). For example, a resource selection procedure may produce a first resource selection 315 for a feedback message (e.g., starting from RB index=K, M_{RB}=16 and M=2, the PUCCH may transmitted over RB={K, K+1}), however, a second resource selection 320 (e.g., a PUCCH transmitted over RB={K+11, K+12}) may be associated with a relatively higher uplink channel quality (e.g., a better uplink channel). Thus, a location of the first resource selection 315 may not be at an optimal point within the resource range 310 (e.g., for improving channel quality). Put another way, some conventional resource selection techniques (e.g., that are not channel aware) may result in degraded communication quality (e.g., as compared to resource selection techniques that are channel aware).

In accordance with one or more aspects of the present disclosure, a network entity 105 and a UE 115 may be configured to perform a channel-based resource selection procedure (e.g., utilizing channel reciprocity inherent in TDD) to improve resource allocations for feedback messages. For example, the channel-based resource selection procedure may enable a network entity 105 and a UE 115 to utilize the second resource selection 320 (e.g., an optimized resource selection, an improved resource selection). In some examples, a UE 115 may inform a network entity 105 of a capability of the UE 115 to support a channel-based resource selectin procedure (e.g., a capability to support channel aware ACK/NACK resource selection), and the network entity 105 may configure the UE 115 to apply channel-based resource selection procedure based on receiving the capability (e.g., an indication of the capability) of the UE 115.

The channel-based resource selection procedure may utilize various mechanisms and techniques to determine (e.g., select, allocate) resources for a feedback message (e.g., a feedback message 225). In some examples, a set of rules (e.g., resource selection rules, an algorithm) may be configured at a network entity 105 and a UE 115 (e.g., pre-configured, defined by an industry standard), and the set of rules may be based on a downlink channel. For example, the set of rules may be configured (e.g., defined) to account for one or more channel estimates. The network entity 105 may inform (e.g., indicate, configure, signal) the UE 115 (e.g., via one or more messages 210) which resource selection rule of the set of rules to use for the channel-based resource selection procedure. In such cases, the resource selection rule may be activated or deactivated by a MAC-CE message or via a DCI message (e.g., dynamically).

Additionally, or alternatively, the network entity 105 may signal (e.g., indicate, transmit) one or more resource selection rules for determining the feedback message resource selection, for example, based on configuring one or more parameters (e.g., one or more thresholds) associated with a resource selection rule (e.g., a pre-defined algorithm). That is, the network entity 105 and the UE 115 may be configured with a resource selection rule, and the network entity 105 may indicate one or more parameters that support the resource selection rule (e.g., one or more inputs to the resource selection rule).

Additionally, or alternatively, the network entity 105 and the UE 115 may support an NN algorithm to determine a resource selection (e.g., a second resource selection 320) for a feedback message. In some examples, the network entity 105 may to configure an NN algorithm at the UE 115 (e.g., may configure one or more coefficients of an NN algorithm, the NN may be predefined by an industry standard, among other examples). The NN algorithm may account for (e.g., input) one or more channel estimations (e.g., directly based on the channel, via a predefined feature calculation, based on the one or more coefficients) and may output the feedback message (e.g., ACK/NACK) resource selection. For example, the network entity 105 (e.g., using a propriety algorithm) may define an NN that has inputs (e.g., features, parameters, coefficients) based on channel conditions and that outputs a desired allocation (e.g., a channel aware resource allocation). In some examples, the UE 115 may receive one or more coefficients for an NN algorithm and may suggest (e.g., indicate, transmit, signal) an alternative NN coefficient set (e.g., one or more second NN coefficients). For example, the UE 115 may receive one or more first coefficients (e.g., parameters) for an NN algorithm and may determine that one or more second coefficients are associated with a relatively, higher channel quality than the first coefficients. Accordingly, the UE 115 may update one or more parameters of the NN and may transmit an indication (e.g., of the one or more second coefficients) to the network entity 105.

Additionally, or alternatively, the network entity 105 may be configured to transmit an indication of a resource allocation (e.g., an explicit resource allocation, per slot) for the feedback message. For example, the network entity 105 may transmit an index associated with one or more frequency resources 335 (e.g., an index associated with the second resource selection 320) that are to be used for an uplink feedback message (e.g., an ACK/NACK). In such examples, the network entity 105 may transmit a control message (e.g., a MAC-CE message, a dynamic DCI message) which may activate or deactivate the resource allocation signaled from the network entity 105.

In some examples, both a network entity 105 and a UE 115 may perform a same channel-based resource selection procedure (e.g., both a receiver and a selection mechanism may be aligned, may support a resource selection alignment between devices). For example, the network entity 105 and the UE 115 may use a same NN algorithm, which may produce a same resource selection (e.g., assuming that the inputs and/or NN coefficients are the same), based on enhancements introduced by the network entity 105 being embedded in the NN coefficients (e.g., while the UE may be agnostic). Additionally, a feedback message (e.g., a UCI) resource allocation may depend on various parameters (e.g., in addition to the channel estimation). For example, the network entity 105 may consider other UEs 115 (e.g., a quantity of UEs 115), a format (e.g., PUCCH format), a payload size of the feedback message, one or more allocation constraints, and a TDD slot structure, among other examples. Each parameter may be available to both a network entity 105 and a UE 115 (e.g., known on both sides), as such both a network entity 105 and a UE 115 may utilize a same channel-based resource selection procedure (e.g., a same algorithm or NN) with the same inputs, which may yield the same outputs.

In some examples, a network entity 105 may schedule multiple UEs 115 simultaneously and may support some flexibility for a resource selection per UE 115. For example, a resource selection list size for the channel-based resource selection procedure (e.g., the algorithm, the resource selection rule, the NN algorithm) may be relatively long (e.g., might have a list size longer than one) to support multiple possibilities (e.g., may suggest a few possibilities to a scheduler). The list size may be a parameter that is conveyed (e.g., indicated, signaled) to the UE 115 (e.g., for an NN algorithm). In such examples, the network entity 105 may also transmit an output index (e.g., an index associated with a resource selection procedure from the list) to the UE 115. In some examples, bandwidth allocations (e.g., bandwidth boundaries) may be pre-determined (e.g., configured) and signaled by the network entity 105 per UE 115. The bandwidth allocations may also be input parameters for the channel-based resource selection procedure 215 (e.g., algorithm, NN).

In some examples, a PUCCH resource allocation for UCI may be greater than or equal to four bits. The techniques described herein may also apply for such examples. Additionally, or alternatively, a DCI-based signaled RB location (e.g., or NN-based selected RB) may be used for the location of the used RB middle instead of an RB start (e.g., a middle RB instead of a first RB). For instance, a signaled or selected frequency resource 335 may correspond to a middle frequency resource 335 (e.g., RB middle, M_{RB,min}^{PUCCH} middle) rather than a starting frequency resource 335. In such examples, the used frequency resources 335 (e.g., the used RB (M_{RB,min}^{PUCCH})) for the resource allocation may be concentrated around a frequency resource 335 associated with a relatively highest channel quality (e.g., an enhanced uplink BWP channel location).

Accordingly, the channel-based resource selection procedure may enable a wireless communication system to improve communication reliability by enhancing resource selection for uplink feedback messages (e.g., increasing a probability to receive ACK/NACK). The described techniques may further improve device coordination by providing resource selection alignment between a UE 115 and a network entity 105. By communicating feedback message in accordance with channel-based resource selection procedures, a wireless communications system may reduce redundant resource usage and may support improved throughput of one or more UEs 115.

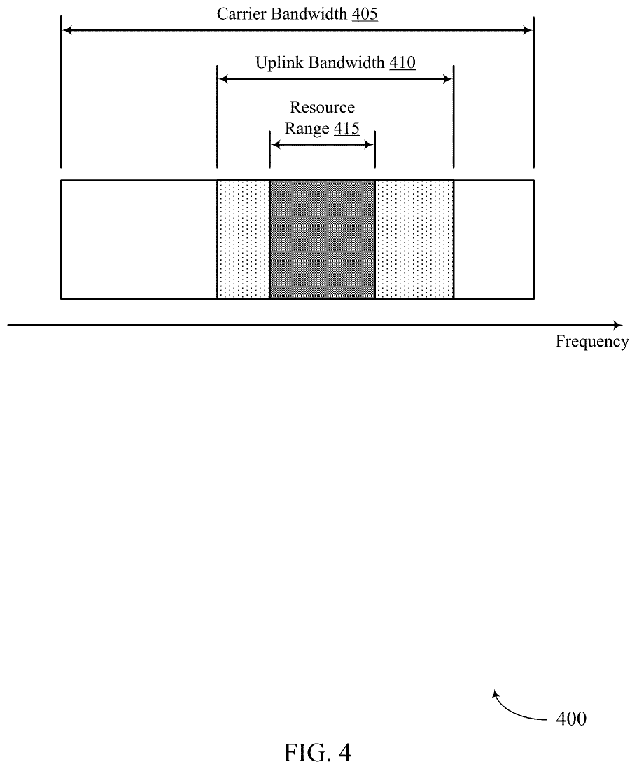

FIG. 4 shows an example of a resource configuration 400 that supports channel-based resource selection for feedback messages in accordance with one or more aspects of the present disclosure. The resource configuration 400 may illustrate a resource range 415 (e.g., a BWP_{PUCCH,span}, a PUCCH resource allocation) within an uplink bandwidth 410 (e.g., an uplink BWP, a resource range 310) and a carrier bandwidth 405 (e.g., a bandwidth 305).

In some examples, a PUCCH resource allocation may be less than or equal to two bits. In such examples, a PUCCH single RB allocation may be signaled by a network entity 105 (e.g., explicitly) via a designated DCI bit field. Various other parameters may be identified by (e.g., taken from) a preconfigured resource list, where a selected resource may signaled via a DCI PRI field. A PUCCH resource location bit field width may be determined via a specified calculation (e.g., such as ┌log₂(BWP)┐). Some examples for size reduction associated with a PUCCH resource allocation may include utilizing a comb grid of 2^{k} spacing, thus reducing a bit width by k, or may include a procedure (e.g., either RRC signaling or a MAC-CE signaling) for narrowing the resource range 415 (e.g., the PUCCH BWP span, BWP_{PUCCH span}≤BWP) within the uplink bandwidth 410 (e.g., an active BWP), thus reducing a bit field (e.g., by ┌log₂(BWP−BWP_{PUCCH span})┐ bits).

Additionally, or alternatively, a network entity 105 and a UE 115 may utilize a same NN algorithm (e.g., under a channel reciprocity assumption) for a PUCCH resource selection (e.g., for a selection of the resource range 415). In such examples, an entire span of the uplink bandwidth 410 (e.g., an uplink BWP span) may be available (e.g., instead of a preconfigured list). Moreover, such examples may not involve additional RRC signaling overhead (e.g., for updating a resource list according to uplink channel variations). Additionally, when utilizing an NN algorithm, configuration of a resource selection procedure may be performed without an additional DCI bit field.

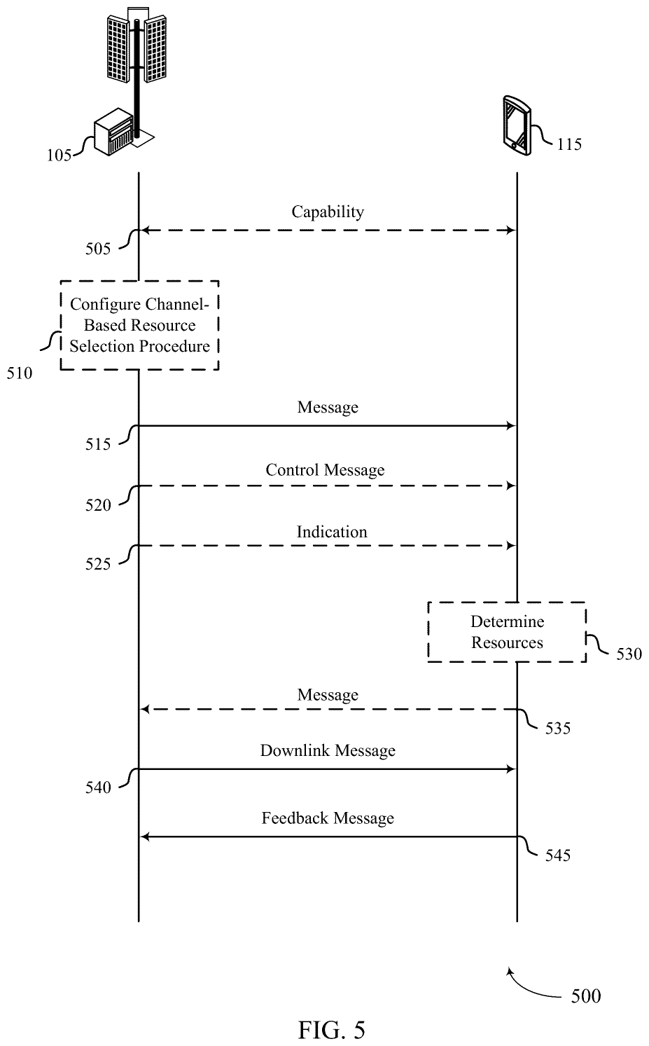

FIG. 5 shows an example of a process flow 500 that supports channel-based resource selection for feedback messages in accordance with one or more aspects of the present disclosure. In some examples, process flow 500 may implement aspects of the wireless communications system 100, the wireless communications system 200, the resource configuration 300, and the resource configuration 400. For example, the process flow 500 may support signaling between a UE 115 and a network entity 105 and procedures to enable channel-based resource selection procedures for a feedback message (e.g., a feedback message 225, a UCI, an ACK/NACK message). The UE 115 and the network entity 105 of the process flow 500 may be examples of corresponding devices described herein, including with reference to FIGS. 1 through 4.

In the following description of process flow 500, the operations between the UE 115 and the network entity 105 may be performed in a different order than the order shown, or other operations may be added or removed from the process flow 500. For example, some operations may also be left out of process flow 500, or may be performed in different orders or at different times. Further, although some operations or signaling may be shown to occur at different times for discussion purposes, these operations may actually occur at the same time. Although the UE 115 and the network entity 105 are shown performing the operations of process flow 500, some aspects of some operations may also be performed by one or more other wireless or network devices.

At 505, the UE 115 may transmit (e.g., a network entity 105 may receive or obtain) a capability message indicating one or more capabilities associated with a channel-based resource selection procedure (e.g., a channel-based resource selection procedure 215, a capability to support a channel-based resource selection procedure). That is, the UE 115 may inform the network entity 105 of channel aware ACK/NACK resource selection (e.g., at initial connection). Additionally, in some examples, the network entity 105 may indicate a capability of the network entity 105 to support a channel-based resource selection procedure to the UE 115 (e.g., a capability exchange). In some examples, the channel-based resource selection procedure (e.g., indicated via a message) may be based on the one or more capabilities.

At 510, the network entity 105 may, in some examples, configure a channel-based resource selection procedure (e.g., channel aware ACK/NACK resource selection). For example, the network entity 105 may determine (e.g., configure) what type of rules (e.g., resource selection rules, algorithms, NN algorithms, explicit resource indication, a selection of a pre-defined rules) to use for the channel-based resource selection procedure 215 (e.g., for determining the channel based ACK/NACK resource selection).

At 515, the UE 115 may receive (e.g., the network entity 105 may output or transmit) a message (e.g., one or more messages 210) indicating the channel-based resource selection procedure for a feedback message (e.g., a feedback message 225). In some examples, the channel-based resource selection procedure may be based on one or more channel estimates (e.g., one or more channel estimates 230). The message may indicate information associated with the channel-based resource selection procedure. In some examples, the UE 115 may receive, via the message, an indication of a resource selection rule of a set of multiple resource selection rules configured at the UE (e.g., preconfigured, predefined by an industry standard). In such examples, the channel-based resource selection procedure may correspond to the resource selection rule. Additionally, or alternatively, the UE 115 may receive, via the message, an indication of one or more parameters associated with a resource selection rule. In such examples, the one or more parameters may include one or more thresholds associated with the resource selection rule, and the channel-based resource selection procedure may correspond to the resource selection rule.

In some examples, the UE 115 may receive, via the message, an indication of one or more coefficients (e.g., parameters) associated with an NN algorithm. In such examples, the channel-based resource selection procedure may correspond to the NN algorithm. In some examples, the UE 115 may receive, via the message, an indication (e.g., an explicit indication) of an allocation of a set of resources associated with an uplink channel. In such examples, the channel-based resource selection procedure may include determining the set of resources in accordance with the allocation. In some examples, the channel-based resource selection procedure may be further based on a quantity of UEs, a format of a feedback message, a payload size of the feedback message, an allocation configuration, a slot structure, or any combination thereof. Additionally, or alternatively, the UE 115 may receive, via the message, an indication of a set of multiple channel-based resource selection procedures including the channel-based resource selection procedure. The message may indicate the channel-based resource selection procedure based on an index included in the message that corresponds to the channel-based resource selection procedure.

At 520, the UE 115 may, in some examples, receive a control message that activates or deactivates a resource selection rule. The control message may be received via a MAC-CE, a DCI message, or both. Additionally, or alternatively, the UE 115 may receive the control message that activates or deactivates an allocation for the set of resources. The control message may be received via MAC-CE, a DCI message, or both. That is, in some examples, the channel-based resource selection procedure may be based on the control message. At 525, the UE 115 may, in some examples, receive (e.g., the network entity 105 may output or transmit) an indication of a bandwidth allocation for the UE 115. In such examples, a set of resources for a feedback message may be determined (e.g., selected) based on the bandwidth allocation and in accordance with the channel-based resource selection procedure.

At 530, the UE 115 may, in some examples, apply (e.g., perform) the channel-based resource selection procedure (e.g., the channel aware ACK/NACK resource selection parameters) as defined (e.g., configured, signaled) by the network entity 105. In some examples, the UE 115 may determine a set of resources associated with an uplink channel in accordance with a resource selection rule (e.g., signaled via the message) and the one or more channel estimates. That is, the set of resources associated with the uplink channel may be based on the resource selection rule and the one or more channel estimates. Additionally, or alternatively, the UE 115 may determine the set of resources associated with the uplink channel using the one or more parameters (e.g., one or more thresholds) and the resource selection rule. That is, the set of resources associated with the uplink channel may be based on the one or more parameters and the resource selection rule. Additionally, or alternatively, the UE 115 may determine the set of resources associated with the uplink channel using the one or more coefficients associated with the NN algorithm. That is, the set of resources associated with the uplink channel may be based on the one or more coefficients associated with the NN algorithm. In some examples, the network entity 105 may additionally, or alternatively, perform the channel-based resource selection procedure, and may arrive at a same result for the resource allocation (e.g., the channel-based resource selection procedure may be deterministic).

At 535, the UE 115 may (e.g., periodically) report (e.g., transmit, indicate) suggested changes to rules (e.g., to rule selections, to one or more algorithm thresholds, to one or more coefficients of an NN), which may be either acknowledged or ignored by network entity 105. That is, the network entity 105 may determine to update the channel-based resource selection procedure or may use the original channel-based resource selection procedure signaled to the UE 115. The UE 115 may, in some examples, transmit (e.g., the network entity 105 may obtain or receive) a second message indicating one or more second coefficients (e.g., parameters, updated coefficients) for the NN algorithm based on the indication of the one or more parameters. In some examples, at least one of the one or more second coefficients may be different from the one or more coefficients.

At 540, the UE 115 may receive (e.g., the network entity 105 may output or transmit) a downlink message (e.g., a downlink message 220, a PDSCH, a PDCCH) via a downlink channel (e.g., a communication link 205-a). For example, the network entity 105 may send a new PDSCH transmission. In such examples, the UE 115 may decode the downlink message and may send a feedback message (e.g., an ACK/NACK) in the resource allocation that was selected based on the channel. At 545, the UE 115 may transmit, via a set of resources associated with an uplink channel (e.g., a communication link 205-b) the feedback message. The feedback message may indicate whether the downlink message was successfully decoded by the UE 115. The set of resources may be based on the one or more channel estimates (e.g., performed by the network entity 105, the UE 115, or both) and in accordance with the channel-based resource selection procedure (e.g., signaled by the network entity 105). That is, a determination (e.g., selection, allocation, identification) of the set of resources may account for channel characteristics (e.g., channel estimations, channel measurements, CSI, channel metrics) based on utilizing the channel-based resource selection procedure. The network entity 105 may receive the transmission of the feedback message in a same resource allocation that was selected based on the channel (e.g., the one or more channel estimates, based on performing a same channel-based resource selection procedure as the UE 115).

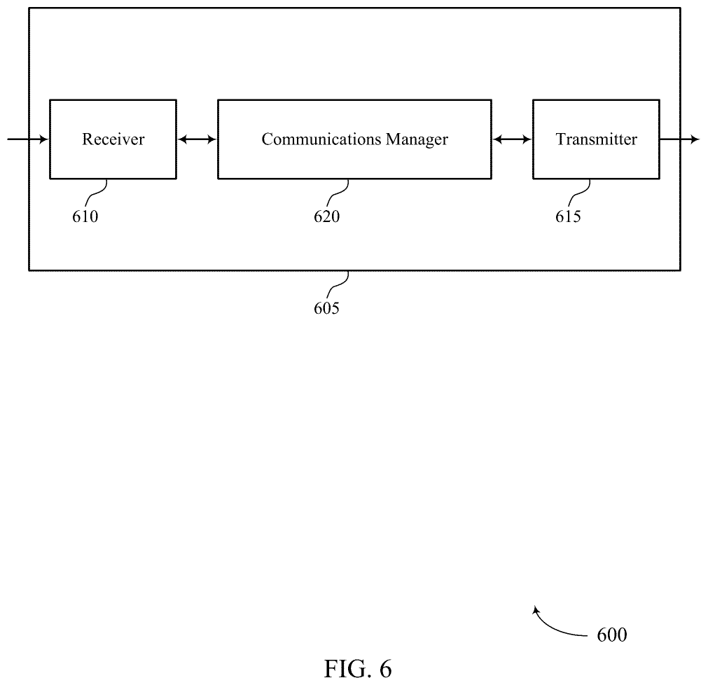

FIG. 6 shows a block diagram 600 of a device 605 that supports channel-based resource selection for feedback messages in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to channel-based resource selection for feedback messages). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel-based resource selection for feedback messages). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of channel-based resource selection for feedback messages as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a message indicating a channel-based resource selection procedure for a feedback message, where the channel-based resource selection procedure is based on one or more channel estimates. The communications manager 620 is capable of, configured to, or operable to support a means for receiving a downlink message via a downlink channel. The communications manager 620 is capable of, configured to, or operable to support a means for transmitting, via a set of resources associated with an uplink channel, the feedback message indicating whether the downlink message was successfully decoded, where the set of resources is based on the one or more channel estimates and in accordance with the channel-based resource selection procedure.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

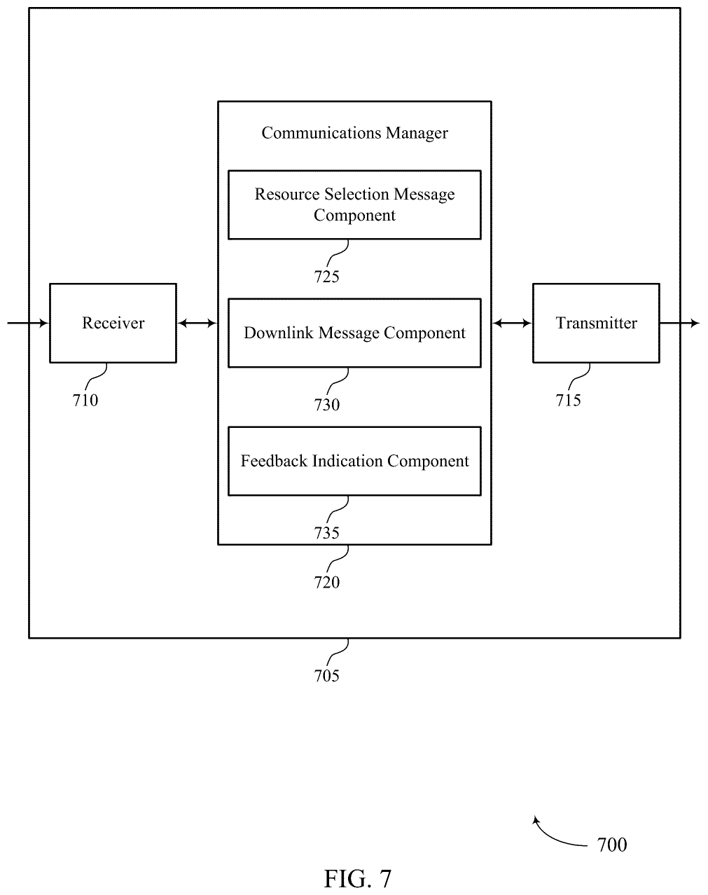

FIG. 7 shows a block diagram 700 of a device 705 that supports channel-based resource selection for feedback messages in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to channel-based resource selection for feedback messages). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel-based resource selection for feedback messages). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel-based resource selection for feedback messages as described herein. For example, the communications manager 720 may include a resource selection message component 725, a downlink message component 730, a feedback indication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The resource selection message component 725 is capable of, configured to, or operable to support a means for receiving a message indicating a channel-based resource selection procedure for a feedback message, where the channel-based resource selection procedure is based on one or more channel estimates. The downlink message component 730 is capable of, configured to, or operable to support a means for receiving a downlink message via a downlink channel. The feedback indication component 735 is capable of, configured to, or operable to support a means for transmitting, via a set of resources associated with an uplink channel, the feedback message indicating whether the downlink message was successfully decoded, where the set of resources is based on the one or more channel estimates and in accordance with the channel-based resource selection procedure.

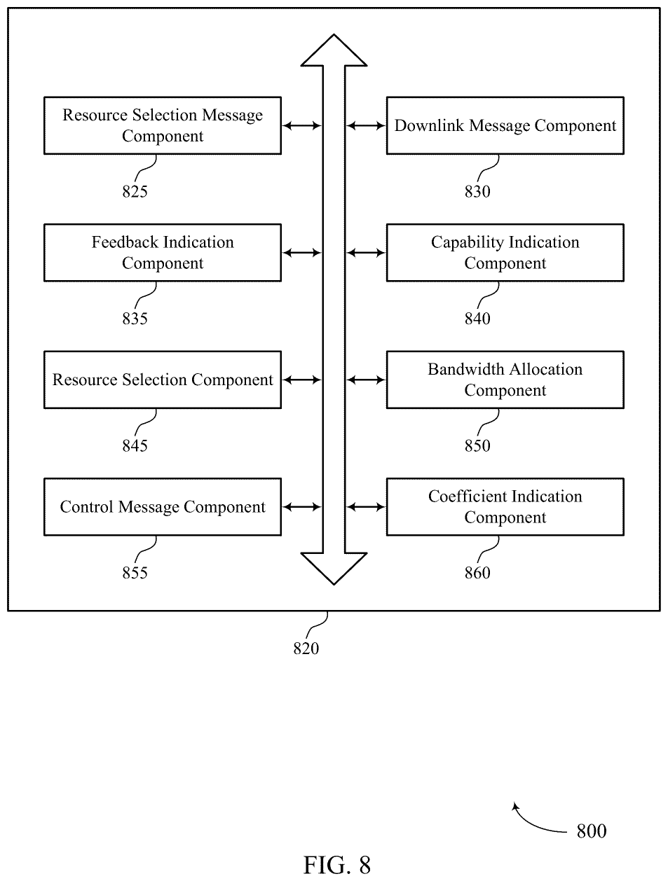

FIG. 8 shows a block diagram 800 of a communications manager 820 that supports channel-based resource selection for feedback messages in accordance with one or more aspects of the present disclosure. The communications manager 820 may be an example of aspects of a communications manager 620, a communications manager 720, or both, as described herein. The communications manager 820, or various components thereof, may be an example of means for performing various aspects of channel-based resource selection for feedback messages as described herein. For example, the communications manager 820 may include a resource selection message component 825, a downlink message component 830, a feedback indication component 835, a capability indication component 840, a resource selection component 845, a bandwidth allocation component 850, a control message component 855, a coefficient indication component 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The resource selection message component 825 is capable of, configured to, or operable to support a means for receiving a message indicating a channel-based resource selection procedure for a feedback message, where the channel-based resource selection procedure is based on one or more channel estimates. The downlink message component 830 is capable of, configured to, or operable to support a means for receiving a downlink message via a downlink channel. The feedback indication component 835 is capable of, configured to, or operable to support a means for transmitting, via a set of resources associated with an uplink channel, the feedback message indicating whether the downlink message was successfully decoded, where the set of resources is based on the one or more channel estimates and in accordance with the channel-based resource selection procedure.

In some examples, the capability indication component 840 is capable of, configured to, or operable to support a means for transmitting a capability message indicating one or more capabilities associated with the channel-based resource selection procedure, where the channel-based resource selection procedure indicated via the message is based on the one or more capabilities.

In some examples, the resource selection message component 825 is capable of, configured to, or operable to support a means for receiving, via the message, an indication of a resource selection rule of a set of multiple resource selection rules configured at the UE, where the channel-based resource selection procedure corresponds to the resource selection rule. In some examples, the resource selection component 845 is capable of, configured to, or operable to support a means for determining the set of resources associated with the uplink channel in accordance with the resource selection rule and the one or more channel estimates.

In some examples, the control message component 855 is capable of, configured to, or operable to support a means for receiving a control message that activates or deactivates the resource selection rule, where the control message is received via a medium access control-control element (MAC-CE), a DCI message, or both.

In some examples, the resource selection message component 825 is capable of, configured to, or operable to support a means for receiving, via the message, an indication of one or more parameters associated with a resource selection rule, where the channel-based resource selection procedure corresponds to the resource selection rule. In some examples, the resource selection component 845 is capable of, configured to, or operable to support a means for determining the set of resources associated with the uplink channel using the one or more parameters and the resource selection rule.

In some examples, the one or more parameters include one or more thresholds associated with the resource selection rule.

In some examples, the resource selection message component 825 is capable of, configured to, or operable to support a means for receiving, via the message, an indication of one or more coefficients associated with an NN algorithm, where the channel-based resource selection procedure corresponds to the NN algorithm. In some examples, the resource selection component 845 is capable of, configured to, or operable to support a means for determining the set of resources associated with the uplink channel using the one or more coefficients associated with the NN algorithm.

In some examples, the coefficient indication component 860 is capable of, configured to, or operable to support a means for transmitting a second message indicating one or more second coefficients for the NN algorithm based on the indication of the one or more parameters, at least one of the one or more second parameters different from the one or more parameters.

In some examples, the resource selection message component 825 is capable of, configured to, or operable to support a means for receiving, via the message, an indication of an allocation of the set of resources associated with the uplink channel, where the channel-based resource selection procedure includes determining the set of resources in accordance with the allocation.

In some examples, the control message component 855 is capable of, configured to, or operable to support a means for receiving a control message that activates or deactivates the allocation for the set of resources, where the control message is received via a medium access control-control element (MAC-CE), a DCI message, or both.

In some examples, the channel-based resource selection procedure is further based on a quantity of UEs, a format of the feedback message, a payload size of the feedback message, an allocation configuration, a slot structure, or any combination thereof.

In some examples, the resource selection message component 825 is capable of, configured to, or operable to support a means for receiving, via the message, an indication of a set of multiple channel-based resource selection procedures including the channel-based resource selection procedure, where the message indicates the channel-based resource selection procedure based on an index included in the message that corresponds to the channel-based resource selection procedure.

In some examples, the bandwidth allocation component 850 is capable of, configured to, or operable to support a means for receiving an indication of a bandwidth allocation for the UE, where the set of resources is based on the bandwidth allocation and in accordance with the channel-based resource selection procedure.

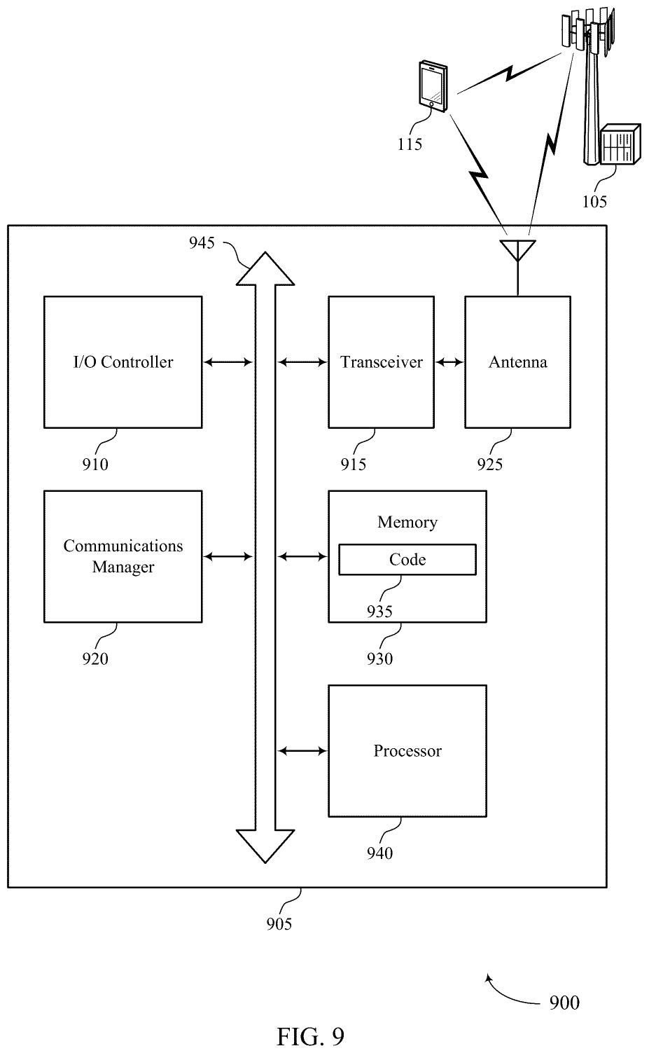

FIG. 9 shows a diagram of a system 900 including a device 905 that supports channel-based resource selection for feedback messages in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting channel-based resource selection for feedback messages). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a message indicating a channel-based resource selection procedure for a feedback message, where the channel-based resource selection procedure is based on one or more channel estimates. The communications manager 920 is capable of, configured to, or operable to support a means for receiving a downlink message via a downlink channel. The communications manager 920 is capable of, configured to, or operable to support a means for transmitting, via a set of resources associated with an uplink channel, the feedback message indicating whether the downlink message was successfully decoded, where the set of resources is based on the one or more channel estimates and in accordance with the channel-based resource selection procedure.

By including or configuring the communications manager 920 in accordance with examples as described herein, the device 905 may support techniques for improved communication reliability, reduced latency, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of channel-based resource selection for feedback messages as described herein, or the at least one processor 940 and the at least one memory 930 may be otherwise configured to, individually or collectively, perform or support such operations.

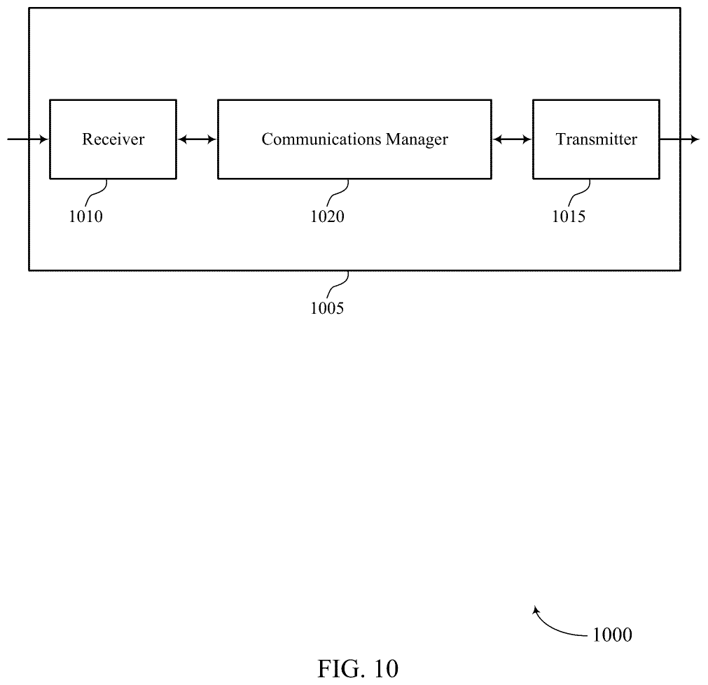

FIG. 10 shows a block diagram 1000 of a device 1005 that supports channel-based resource selection for feedback messages in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of channel-based resource selection for feedback messages as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a message indicating a channel-based resource selection procedure for a feedback message, where the channel-based resource selection procedure is based on one or more channel estimates. The communications manager 1020 is capable of, configured to, or operable to support a means for outputting a downlink message via a downlink channel. The communications manager 1020 is capable of, configured to, or operable to support a means for obtaining, via a set of resources associated with an uplink channel, the feedback message indicating whether the downlink message was successfully decoded, where the set of resources are based on the channel-based resource selection procedure.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

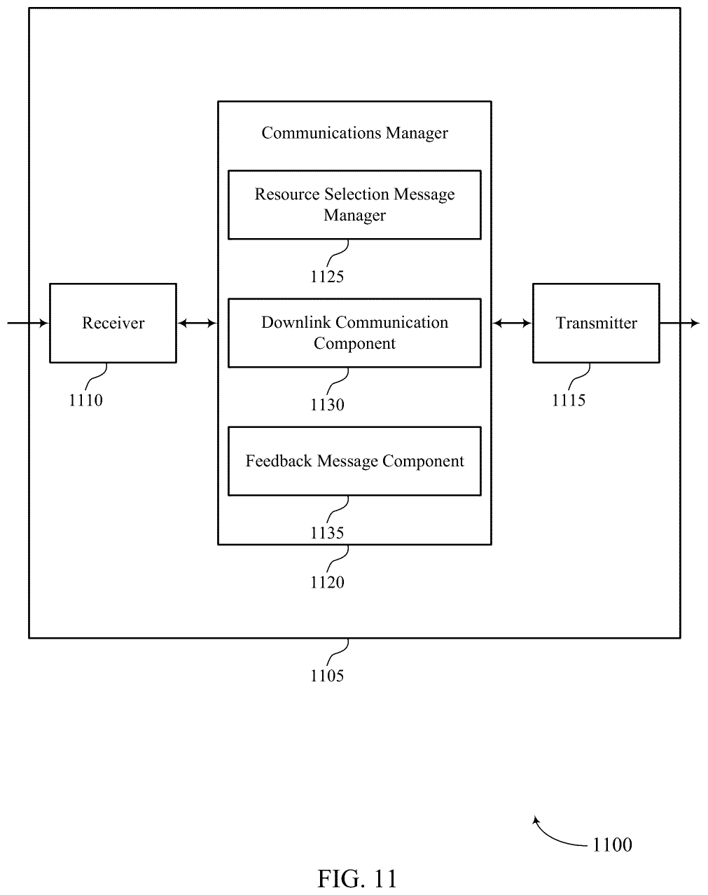

FIG. 11 shows a block diagram 1100 of a device 1105 that supports channel-based resource selection for feedback messages in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of channel-based resource selection for feedback messages as described herein. For example, the communications manager 1120 may include a resource selection message manager 1125, a downlink communication component 1130, a feedback message component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The resource selection message manager 1125 is capable of, configured to, or operable to support a means for outputting a message indicating a channel-based resource selection procedure for a feedback message, where the channel-based resource selection procedure is based on one or more channel estimates. The downlink communication component 1130 is capable of, configured to, or operable to support a means for outputting a downlink message via a downlink channel. The feedback message component 1135 is capable of, configured to, or operable to support a means for obtaining, via a set of resources associated with an uplink channel, the feedback message indicating whether the downlink message was successfully decoded, where the set of resources are based on the channel-based resource selection procedure.

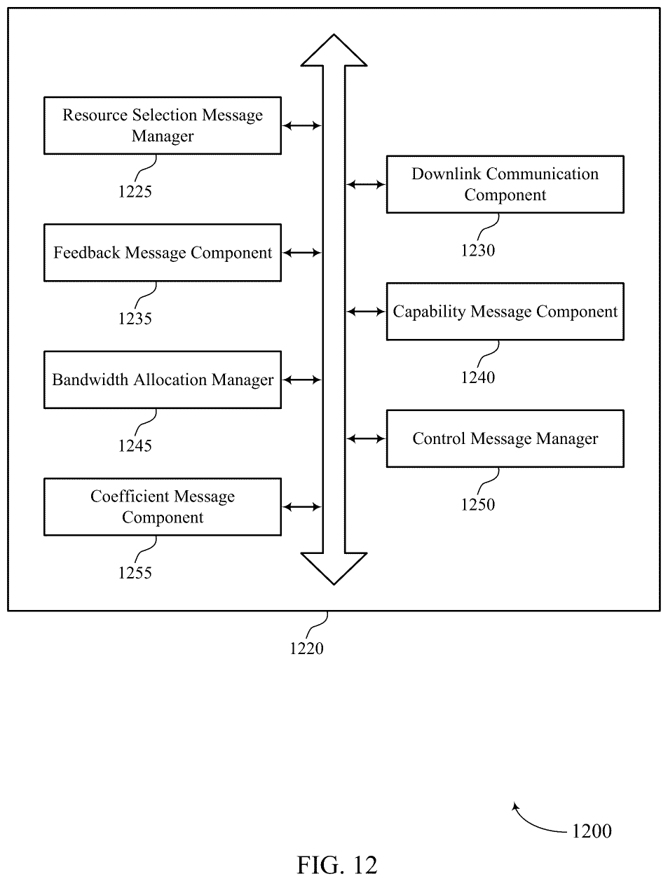

FIG. 12 shows a block diagram 1200 of a communications manager 1220 that supports channel-based resource selection for feedback messages in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of channel-based resource selection for feedback messages as described herein. For example, the communications manager 1220 may include a resource selection message manager 1225, a downlink communication component 1230, a feedback message component 1235, a capability message component 1240, a bandwidth allocation manager 1245, a control message manager 1250, a coefficient message component 1255, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The resource selection message manager 1225 is capable of, configured to, or operable to support a means for outputting a message indicating a channel-based resource selection procedure for a feedback message, where the channel-based resource selection procedure is based on one or more channel estimates. The downlink communication component 1230 is capable of, configured to, or operable to support a means for outputting a downlink message via a downlink channel. The feedback message component 1235 is capable of, configured to, or operable to support a means for obtaining, via a set of resources associated with an uplink channel, the feedback message indicating whether the downlink message was successfully decoded, where the set of resources are based on the channel-based resource selection procedure.

In some examples, the capability message component 1240 is capable of, configured to, or operable to support a means for obtaining a capability message indicating one or more capabilities of a UE associated with the channel-based resource selection procedure, where the channel-based resource selection procedure indicated via the message is based on the one or more capabilities.

In some examples, the resource selection message manager 1225 is capable of, configured to, or operable to support a means for outputting, via the message, an indication of a resource selection rule of a set of multiple resource selection rules configured at the network entity, where the channel-based resource selection procedure corresponds to the resource selection rule, and where the set of resources associated with the uplink channel is based on the resource selection rule and the one or more channel estimates.

In some examples, the control message manager 1250 is capable of, configured to, or operable to support a means for outputting a control message that activates or deactivates the resource selection rule, where the control message is received via a medium access control-control element (MAC-CE), a DCI message, or both.

In some examples, the resource selection message manager 1225 is capable of, configured to, or operable to support a means for outputting, via the message, an indication of one or more parameters associated with a resource selection rule, where the channel-based resource selection procedure corresponds to the resource selection rule, where the set of resources associated with the uplink channel is based on the one or more parameters and the resource selection rule.

In some examples, the one or more parameters include one or more thresholds associated with the resource selection rule.

In some examples, the resource selection message manager 1225 is capable of, configured to, or operable to support a means for outputting, via the message, an indication of one or more coefficients associated with an NN algorithm, where the channel-based resource selection procedure corresponds to the NN algorithm, where the set of resources associated with the uplink channel is based on the one or more coefficients associated with the NN algorithm.

In some examples, the coefficient message component 1255 is capable of, configured to, or operable to support a means for obtaining a second message indicating one or more second coefficients for the NN algorithm based on the indication of the one or more parameters, at least one of the one or more second parameters different from the one or more parameters.

In some examples, the resource selection message manager 1225 is capable of, configured to, or operable to support a means for outputting, via the message, an indication of an allocation of the set of resources associated with the uplink channel, where the channel-based resource selection procedure includes determining the set of resources in accordance with the allocation.

In some examples, the control message manager 1250 is capable of, configured to, or operable to support a means for outputting a control message that activates or deactivates the allocation for the set of resources, where the control message is received via a medium access control-control element (MAC-CE), a DCI message, or both.

In some examples, the channel-based resource selection procedure is further based on a quantity of user equipments (UEs), a format of the feedback message, a payload size of the feedback message, an allocation configuration, a slot structure, or any combination thereof.

In some examples, the resource selection message manager 1225 is capable of, configured to, or operable to support a means for outputting, via the message, an indication of a set of multiple channel-based resource selection procedures including the channel-based resource selection procedure, where the message indicates the channel-based resource selection procedure based on an index included in the message that corresponds to the channel-based resource selection procedure.

In some examples, the bandwidth allocation manager 1245 is capable of, configured to, or operable to support a means for outputting an indication of a bandwidth allocation for a UE, where the set of resources is determined based on the bandwidth allocation and in accordance with the channel-based resource selection procedure.

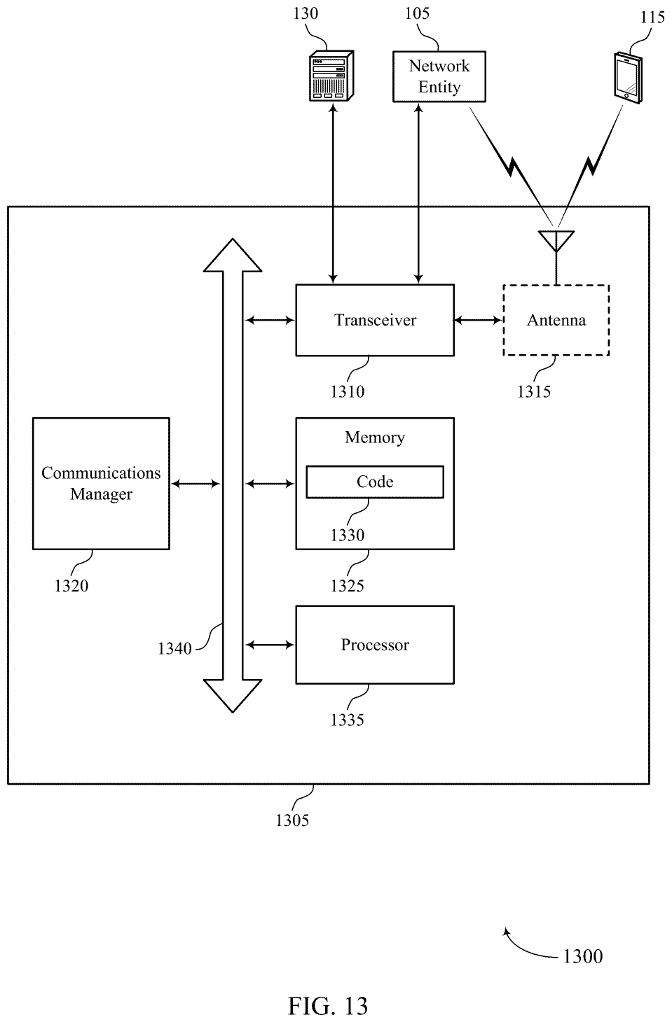

FIG. 13 shows a diagram of a system 1300 including a device 1305 that supports channel-based resource selection for feedback messages in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting channel-based resource selection for feedback messages). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with ULEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a message indicating a channel-based resource selection procedure for a feedback message, where the channel-based resource selection procedure is based on one or more channel estimates. The communications manager 1320 is capable of, configured to, or operable to support a means for outputting a downlink message via a downlink channel. The communications manager 1320 is capable of, configured to, or operable to support a means for obtaining, via a set of resources associated with an uplink channel, the feedback message indicating whether the downlink message was successfully decoded, where the set of resources are based on the channel-based resource selection procedure.

By including or configuring the communications manager 1320 in accordance with examples as described herein, the device 1305 may support techniques for improved communication reliability, reduced latency, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of channel-based resource selection for feedback messages as described herein, or the at least one processor 1335 and the at least one memory 1325 may be otherwise configured to, individually or collectively, perform or support such operations.

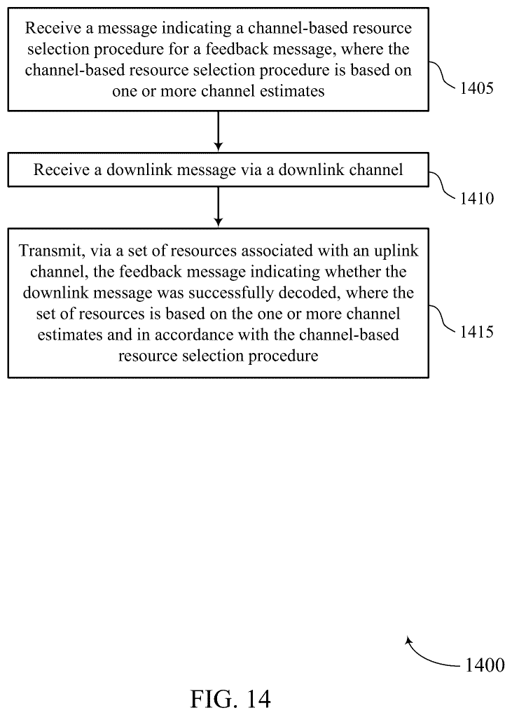

FIG. 14 shows a flowchart illustrating a method 1400 that supports channel-based resource selection for feedback messages in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a message indicating a channel-based resource selection procedure for a feedback message, where the channel-based resource selection procedure is based on one or more channel estimates. The operations of 1405 may be performed in accordance with examples as disclosed herein. In some examples, aspects of the operations of 1405 may be performed by a resource selection message component 825 as described with reference to FIG. 8.

At 1410, the method may include receiving a downlink message via a downlink channel. The operations of 1410 may be performed in accordance with examples as disclosed herein. In some examples, aspects of the operations of 1410 may be performed by a downlink message component 830 as described with reference to FIG. 8.

At 1415, the method may include transmitting, via a set of resources associated with an uplink channel, the feedback message indicating whether the downlink message was successfully decoded, where the set of resources is based on the one or more channel estimates and in accordance with the channel-based resource selection procedure. The operations of 1415 may be performed in accordance with examples as disclosed herein. In some examples, aspects of the operations of 1415 may be performed by a feedback indication component 835 as described with reference to FIG. 8.

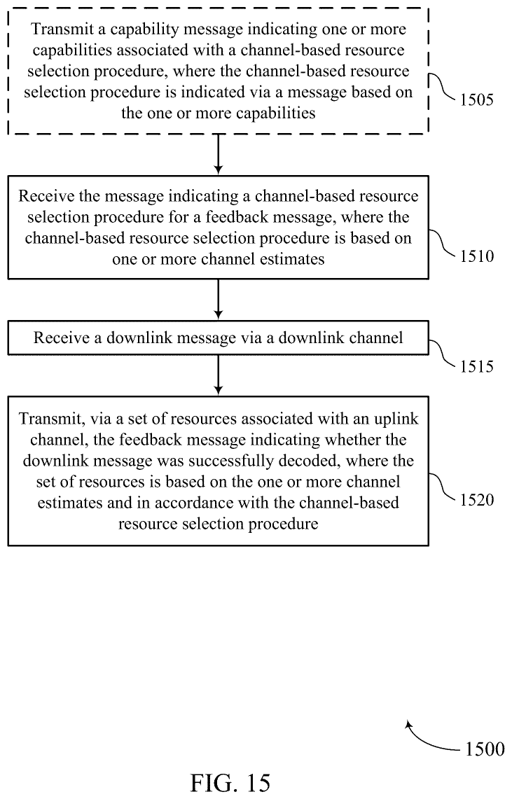

FIG. 15 shows a flowchart illustrating a method 1500 that supports channel-based resource selection for feedback messages in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message indicating one or more capabilities associated with a channel-based resource selection procedure, where the channel-based resource selection procedure is indicated via a message based on the one or more capabilities. The operations of 1505 may be performed in accordance with examples as disclosed herein. In some examples, aspects of the operations of 1505 may be performed by a capability indication component 840 as described with reference to FIG. 8.

At 1510, the method may include receiving the message indicating a channel-based resource selection procedure for a feedback message, where the channel-based resource selection procedure is based on one or more channel estimates. The operations of 1510 may be performed in accordance with examples as disclosed herein. In some examples, aspects of the operations of 1510 may be performed by a resource selection message component 825 as described with reference to FIG. 8.

At 1515, the method may include receiving a downlink message via a downlink channel. The operations of 1515 may be performed in accordance with examples as disclosed herein. In some examples, aspects of the operations of 1515 may be performed by a downlink message component 830 as described with reference to FIG. 8.

At 1520, the method may include transmitting, via a set of resources associated with an uplink channel, the feedback message indicating whether the downlink message was successfully decoded, where the set of resources is based on the one or more channel estimates and in accordance with the channel-based resource selection procedure. The operations of 1520 may be performed in accordance with examples as disclosed herein. In some examples, aspects of the operations of 1520 may be performed by a feedback indication component 835 as described with reference to FIG. 8.

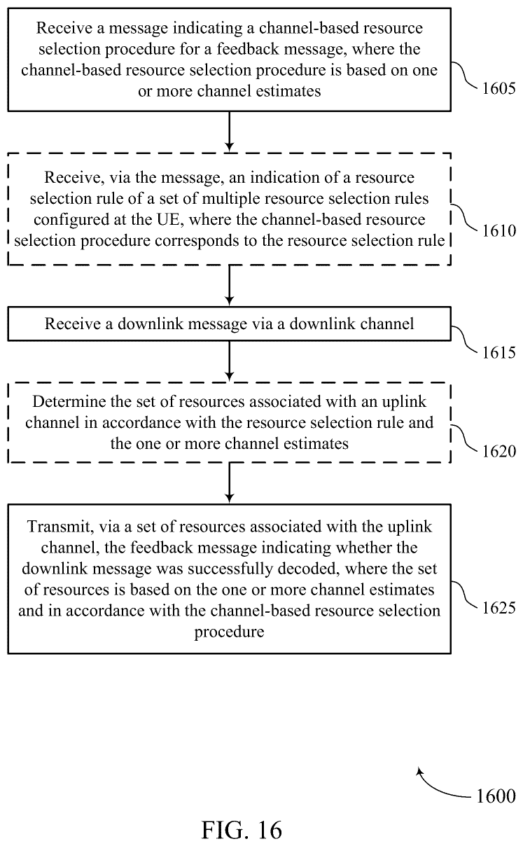

FIG. 16 shows a flowchart illustrating a method 1600 that supports channel-based resource selection for feedback messages in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a message indicating a channel-based resource selection procedure for a feedback message, where the channel-based resource selection procedure is based on one or more channel estimates. The operations of 1605 may be performed in accordance with examples as disclosed herein. In some examples, aspects of the operations of 1605 may be performed by a resource selection message component 825 as described with reference to FIG. 8.

At 1610, the method may include receiving, via the message, an indication of a resource selection rule of a set of multiple resource selection rules configured at the UE, where the channel-based resource selection procedure corresponds to the resource selection rule. The operations of 1610 may be performed in accordance with examples as disclosed herein. In some examples, aspects of the operations of 1610 may be performed by a resource selection message component 825 as described with reference to FIG. 8.

At 1615, the method may include receiving a downlink message via a downlink channel. The operations of 1615 may be performed in accordance with examples as disclosed herein. In some examples, aspects of the operations of 1615 may be performed by a downlink message component 830 as described with reference to FIG. 8.

At 1620, the method may include determining the set of resources associated with an uplink channel in accordance with the resource selection rule and the one or more channel estimates. The operations of 1620 may be performed in accordance with examples as disclosed herein. In some examples, aspects of the operations of 1620 may be performed by a resource selection component 845 as described with reference to FIG. 8.

At 1625, the method may include transmitting, via a set of resources associated with the uplink channel, the feedback message indicating whether the downlink message was successfully decoded, where the set of resources is based on the one or more channel estimates and in accordance with the channel-based resource selection procedure. The operations of 1625 may be performed in accordance with examples as disclosed herein. In some examples, aspects of the operations of 1625 may be performed by a feedback indication component 835 as described with reference to FIG. 8.

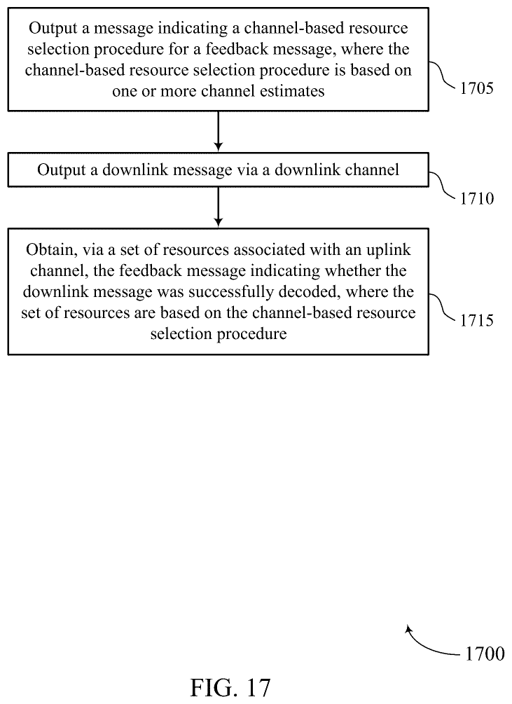

FIG. 17 shows a flowchart illustrating a method 1700 that supports channel-based resource selection for feedback messages in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting a message indicating a channel-based resource selection procedure for a feedback message, where the channel-based resource selection procedure is based on one or more channel estimates. The operations of 1705 may be performed in accordance with examples as disclosed herein. In some examples, aspects of the operations of 1705 may be performed by a resource selection message manager 1225 as described with reference to FIG. 12.

At 1710, the method may include outputting a downlink message via a downlink channel. The operations of 1710 may be performed in accordance with examples as disclosed herein. In some examples, aspects of the operations of 1710 may be performed by a downlink communication component 1230 as described with reference to FIG. 12.

At 1715, the method may include obtaining, via a set of resources associated with an uplink channel, the feedback message indicating whether the downlink message was successfully decoded, where the set of resources are based on the channel-based resource selection procedure. The operations of 1715 may be performed in accordance with examples as disclosed herein. In some examples, aspects of the operations of 1715 may be performed by a feedback message component 1235 as described with reference to FIG. 12.

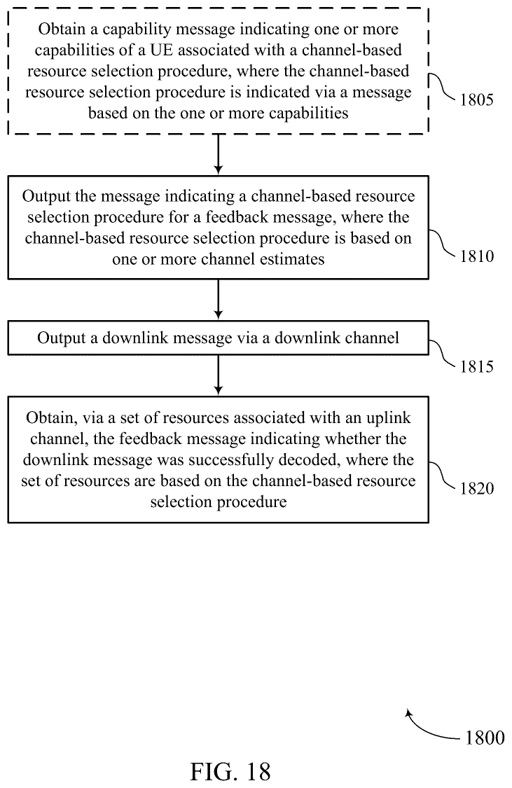

FIG. 18 shows a flowchart illustrating a method 1800 that supports channel-based resource selection for feedback messages in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include obtaining a capability message indicating one or more capabilities of a UE associated with a channel-based resource selection procedure, where the channel-based resource selection procedure is indicated via a message based on the one or more capabilities. The operations of 1805 may be performed in accordance with examples as disclosed herein. In some examples, aspects of the operations of 1805 may be performed by a capability message component 1240 as described with reference to FIG. 12.

At 1810, the method may include outputting the message indicating a channel-based resource selection procedure for a feedback message, where the channel-based resource selection procedure is based on one or more channel estimates. The operations of 1810 may be performed in accordance with examples as disclosed herein. In some examples, aspects of the operations of 1810 may be performed by a resource selection message manager 1225 as described with reference to FIG. 12.

At 1815, the method may include outputting a downlink message via a downlink channel. The operations of 1815 may be performed in accordance with examples as disclosed herein. In some examples, aspects of the operations of 1815 may be performed by a downlink communication component 1230 as described with reference to FIG. 12.

At 1820, the method may include obtaining, via a set of resources associated with an uplink channel, the feedback message indicating whether the downlink message was successfully decoded, where the set of resources are based on the channel-based resource selection procedure. The operations of 1820 may be performed in accordance with examples as disclosed herein. In some examples, aspects of the operations of 1820 may be performed by a feedback message component 1235 as described with reference to FIG. 12.

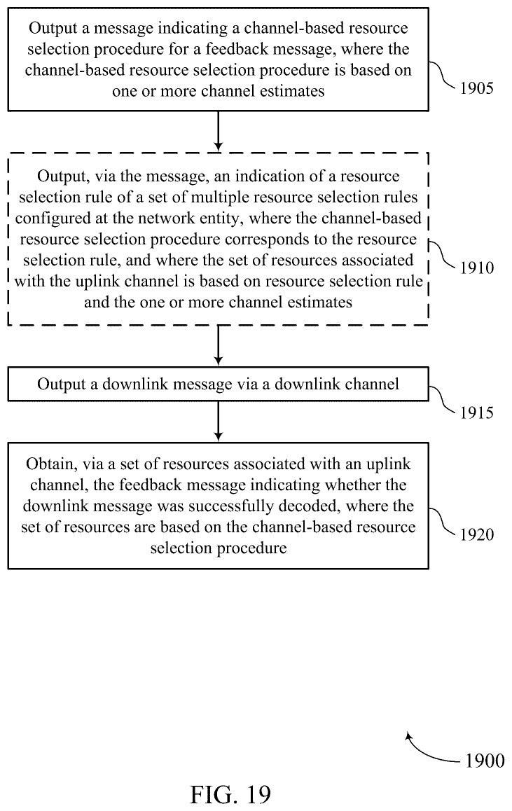

FIG. 19 shows a flowchart illustrating a method 1900 that supports channel-based resource selection for feedback messages in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include outputting a message indicating a channel-based resource selection procedure for a feedback message, where the channel-based resource selection procedure is based on one or more channel estimates. The operations of 1905 may be performed in accordance with examples as disclosed herein. In some examples, aspects of the operations of 1905 may be performed by a resource selection message manager 1225 as described with reference to FIG. 12.

At 1910, the method may include outputting, via the message, an indication of a resource selection rule of a set of multiple resource selection rules configured at the network entity, where the channel-based resource selection procedure corresponds to the resource selection rule, and where the set of resources associated with the uplink channel is based on the resource selection rule and the one or more channel estimates. The operations of 1910 may be performed in accordance with examples as disclosed herein. In some examples, aspects of the operations of 1910 may be performed by a resource selection message manager 1225 as described with reference to FIG. 12.

At 1915, the method may include outputting a downlink message via a downlink channel. The operations of 1915 may be performed in accordance with examples as disclosed herein. In some examples, aspects of the operations of 1915 may be performed by a downlink communication component 1230 as described with reference to FIG. 12.

At 1920, the method may include obtaining, via a set of resources associated with an uplink channel, the feedback message indicating whether the downlink message was successfully decoded, where the set of resources are based on the channel-based resource selection procedure. The operations of 1920 may be performed in accordance with examples as disclosed herein. In some examples, aspects of the operations of 1920 may be performed by a feedback message component 1235 as described with reference to FIG. 12.

The following provides an overview of aspects of the present disclosure:

Aspect 1: A method for wireless communications by a UE, comprising: receiving a message indicating a channel-based resource selection procedure for a feedback message, wherein the channel-based resource selection procedure is based at least in part on one or more channel estimates; receiving a downlink message via a downlink channel; and transmitting, via a set of resources associated with an uplink channel, the feedback message indicating whether the downlink message was successfully decoded, wherein the set of resources is based at least in part on the one or more channel estimates and in accordance with the channel-based resource selection procedure.

Aspect 2: The method of aspect 1, further comprising: transmitting a capability message indicating one or more capabilities associated with the channel-based resource selection procedure, wherein the channel-based resource selection procedure indicated via the message is based at least in part on the one or more capabilities.

Aspect 3: The method of any of aspects 1 through 2, further comprising: receiving, via the message, an indication of a resource selection rule of a plurality of resource selection rules configured at the UE, wherein the channel-based resource selection procedure corresponds to the resource selection rule; and determining the set of resources associated with the uplink channel in accordance with the resource selection rule and the one or more channel estimates.

Aspect 4: The method of aspect 3, further comprising: receiving a control message that activates or deactivates the resource selection rule, wherein the control message is received via a MAC-CE, a DCI message, or both.

Aspect 5: The method of any of aspects 1 through 2, further comprising: receiving, via the message, an indication of one or more parameters associated with a resource selection rule, wherein the channel-based resource selection procedure corresponds to the resource selection rule; and determining the set of resources associated with the uplink channel using the one or more parameters and the resource selection rule.

Aspect 6: The method of aspect 5, wherein the one or more parameters comprise one or more thresholds associated with the resource selection rule.

Aspect 7: The method of any of aspects 1 through 2, further comprising: receiving, via the message, an indication of one or more coefficients associated with a neural network algorithm, wherein the channel-based resource selection procedure corresponds to the neural network algorithm; and determining the set of resources associated with the uplink channel using the one or more coefficients associated with the neural network algorithm.

Aspect 8: The method of aspect 7, further comprising: transmitting a second message indicating one or more second coefficients for the neural network algorithm based at least in part on the indication of the one or more coefficients, at least one of the one or more second coefficients different from the one or more coefficients.

Aspect 9: The method of any of aspects 1 through 2, further comprising: receiving, via the message, an indication of an allocation of the set of resources associated with the uplink channel, wherein the channel-based resource selection procedure comprises determining the set of resources in accordance with the allocation.

Aspect 10: The method of aspect 9, further comprising: receiving a control message that activates or deactivates the allocation for the set of resources, wherein the control message is received via a MAC-CE, a DCI message, or both.

Aspect 11: The method of any of aspects 1 through 10, wherein the channel-based resource selection procedure is further based at least in part on a quantity of UEs, a format of the feedback message, a payload size of the feedback message, an allocation configuration, a slot structure, or any combination thereof.

Aspect 12: The method of any of aspects 1 through 11, further comprising: receiving, via the message, an indication of a plurality of channel-based resource selection procedures including the channel-based resource selection procedure, wherein the message indicates the channel-based resource selection procedure based at least in part on an index included in the message that corresponds to the channel-based resource selection procedure.

Aspect 13: The method of any of aspects 1 through 12, further comprising: receiving an indication of a bandwidth allocation for the UE, wherein the set of resources is based at least in part on the bandwidth allocation and in accordance with the channel-based resource selection procedure.

Aspect 14: A method for wireless communications by network entity, comprising: outputting a message indicating a channel-based resource selection procedure for a feedback message, wherein the channel-based resource selection procedure is based at least in part on one or more channel estimates; outputting a downlink message via a downlink channel; and obtaining, via a set of resources associated with an uplink channel, the feedback message indicating whether the downlink message was successfully decoded, wherein the set of resources are based at least in part on the channel-based resource selection procedure.

Aspect 15: The method of aspect 14, further comprising: obtaining a capability message indicating one or more capabilities of a UE associated with the channel-based resource selection procedure, wherein the channel-based resource selection procedure indicated via the message is based at least in part on the one or more capabilities.

Aspect 16: The method of any of aspects 14 through 15, further comprising: outputting, via the message, an indication of a resource selection rule of a plurality of resource selection rules configured at the network entity, wherein the channel-based resource selection procedure corresponds to the resource selection rule, and wherein the set of resources associated with the uplink channel is based at least in part on the resource selection rule and the one or more channel estimates.

Aspect 17: The method of aspect 16, further comprising: outputting a control message that activates or deactivates the resource selection rule, wherein the control message is received via a MAC-CE, a DCI message, or both.

Aspect 18: The method of any of aspects 14 through 15, further comprising: outputting, via the message, an indication of one or more parameters associated with a resource selection rule, wherein the channel-based resource selection procedure corresponds to the resource selection rule, wherein the set of resources associated with the uplink channel is based at least in part on the one or more parameters and the resource selection rule.

Aspect 19: The method of aspect 18, wherein the one or more parameters comprise one or more thresholds associated with the resource selection rule.

Aspect 20: The method of any of aspects 14 through 15, further comprising: outputting, via the message, an indication of one or more coefficients associated with a neural network algorithm, wherein the channel-based resource selection procedure corresponds to the neural network algorithm, wherein the set of resources associated with the uplink channel is based at least in part on the one or more coefficients associated with the neural network algorithm.

Aspect 21: The method of aspect 20, further comprising: obtaining a second message indicating one or more second coefficients for the neural network algorithm based at least in part on the indication of the one or more coefficients, at least one of the one or more second coefficients different from the one or more coefficients.

Aspect 22: The method of any of aspects 14 through 15, further comprising: outputting, via the message, an indication of an allocation of the set of resources associated with the uplink channel, wherein the channel-based resource selection procedure comprises determining the set of resources in accordance with the allocation.

Aspect 23: The method of aspect 22, further comprising: outputting a control message that activates or deactivates the allocation for the set of resources, wherein the control message is received via a MAC-CE, a DCI message, or both.

Aspect 24: The method of any of aspects 14 through 23, wherein the channel-based resource selection procedure is further based at least in part on a quantity of user equipments (UEs), a format of the feedback message, a payload size of the feedback message, an allocation configuration, a slot structure, or any combination thereof.

Aspect 25: The method of any of aspects 14 through 24, further comprising: outputting, via the message, an indication of a plurality of channel-based resource selection procedures including the channel-based resource selection procedure, wherein the message indicates the channel-based resource selection procedure based at least in part on an index included in the message that corresponds to the channel-based resource selection procedure.

Aspect 26: The method of any of aspects 14 through 25, further comprising: outputting an indication of a bandwidth allocation for a UE, wherein the set of resources is determined based at least in part on the bandwidth allocation and in accordance with the channel-based resource selection procedure.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” may include calculating, computing, processing, deriving, investigating, looking up (such as via looking up in a table, a database or another data structure), ascertaining and the like. Also, “determining” may include receiving (e.g., receiving information), accessing (e.g., accessing data stored in memory) and the like. Also, “determining” may include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a message indicating a channel-based resource selection procedure for a feedback message, wherein the channel-based resource selection procedure is based at least in part on one or more channel estimates;
receive a downlink message via a downlink channel; and
transmit, via a set of resources associated with an uplink channel, the feedback message indicating whether the downlink message was successfully decoded, wherein the set of resources is based at least in part on the one or more channel estimates and in accordance with the channel-based resource selection procedure.

2. The UE of claim 1, wherein the one or more processors are individually or collectively further operable to execute the code to cause the UE to:
transmit a capability message indicating one or more capabilities associated with the channel-based resource selection procedure, wherein the channel-based resource selection procedure indicated via the message is based at least in part on the one or more capabilities.

3. The UE of claim 1, wherein the one or more processors are individually or collectively further operable to execute the code to cause the UE to:
receive, via the message, an indication of a resource selection rule of a plurality of resource selection rules configured at the UE, wherein the channel-based resource selection procedure corresponds to the resource selection rule; and
determine the set of resources associated with the uplink channel in accordance with the resource selection rule and the one or more channel estimates.

4. The UE of claim 3, wherein the one or more processors are individually or collectively further operable to execute the code to cause the UE to:
receive a control message that activates or deactivates the resource selection rule, wherein the control message is received via a medium access control-control element (MAC-CE), a downlink control information (DCI) message, or both.

5. The UE of claim 1, wherein the one or more processors are individually or collectively further operable to execute the code to cause the UE to:
receive, via the message, an indication of one or more parameters associated with a resource selection rule, wherein the channel-based resource selection procedure corresponds to the resource selection rule; and
determine the set of resources associated with the uplink channel using the one or more parameters and the resource selection rule.

6. The UE of claim 5, wherein the one or more parameters comprise one or more thresholds associated with the resource selection rule.

7. The UE of claim 1, wherein the one or more processors are individually or collectively further operable to execute the code to cause the UE to:
receive, via the message, an indication of one or more coefficients associated with a neural network algorithm, wherein the channel-based resource selection procedure corresponds to the neural network algorithm; and
determine the set of resources associated with the uplink channel using the one or more coefficients associated with the neural network algorithm.

8. The UE of claim 7, wherein the one or more processors are individually or collectively further operable to execute the code to cause the UE to:
transmit a second message indicating one or more second coefficients for the neural network algorithm based at least in part on the indication of the one or more coefficients, at least one of the one or more second coefficients different from the one or more coefficients.

9. The UE of claim 1, wherein the one or more processors are individually or collectively further operable to execute the code to cause the UE to:
receive, via the message, an indication of an allocation of the set of resources associated with the uplink channel, wherein the channel-based resource selection procedure comprises determining the set of resources in accordance with the allocation.

10. The UE of claim 9, wherein the one or more processors are individually or collectively further operable to execute the code to cause the UE to:
receive a control message that activates or deactivates the allocation for the set of resources, wherein the control message is received via a medium access control-control element (MAC-CE), a downlink control information (DCI) message, or both.

11. The UE of claim 1, wherein the channel-based resource selection procedure is further based at least in part on a quantity of UEs, a format of the feedback message, a payload size of the feedback message, an allocation configuration, a slot structure, or any combination thereof.

12. The UE of claim 1, wherein the one or more processors are individually or collectively further operable to execute the code to cause the UE to:
receive, via the message, an indication of a plurality of channel-based resource selection procedures including the channel-based resource selection procedure, wherein the message indicates the channel-based resource selection procedure based at least in part on an index included in the message that corresponds to the channel-based resource selection procedure.

13. The UE of claim 1, wherein the one or more processors are individually or collectively further operable to execute the code to cause the UE to:
receive an indication of a bandwidth allocation for the UE, wherein the set of resources is based at least in part on the bandwidth allocation and in accordance with the channel-based resource selection procedure.

14. A network entity, comprising:
one or more memories storing processor-executable code; and
one or more processors coupled with the one or more memories and individually or collectively operable to execute the code to cause the network entity to:
output a message indicating a channel-based resource selection procedure for a feedback message, wherein the channel-based resource selection procedure is based at least in part on one or more channel estimates;
output a downlink message via a downlink channel; and
obtain, via a set of resources associated with an uplink channel, the feedback message indicating whether the downlink message was successfully decoded, wherein the set of resources are based at least in part on the channel-based resource selection procedure.

15. The network entity of claim 14, wherein the one or more processors are individually or collectively further operable to execute the code to cause the network entity to:
obtain a capability message indicating one or more capabilities of a user equipment (UE) associated with the channel-based resource selection procedure, wherein the channel-based resource selection procedure indicated via the message is based at least in part on the one or more capabilities.

16. The network entity of claim 14, wherein the one or more processors are individually or collectively further operable to execute the code to cause the network entity to:
output, via the message, an indication of a resource selection rule of a plurality of resource selection rules configured at the network entity, wherein the channel-based resource selection procedure corresponds to the resource selection rule, and wherein the set of resources associated with the uplink channel is based at least in part on the resource selection rule and the one or more channel estimates.

17. The network entity of claim 16, wherein the one or more processors are individually or collectively further operable to execute the code to cause the network entity to:
output a control message that activates or deactivates the resource selection rule, wherein the control message is received via a medium access control-control element (MAC-CE), a downlink control information (DCI) message, or both.

18. The network entity of claim 14, wherein the one or more processors are individually or collectively further operable to execute the code to cause the network entity to:
output, via the message, an indication of one or more parameters associated with a resource selection rule, wherein the channel-based resource selection procedure corresponds to the resource selection rule, wherein the set of resources associated with the uplink channel is based at least in part on the one or more parameters and the resource selection rule.

19. The network entity of claim 18, wherein the one or more parameters comprise one or more thresholds associated with the resource selection rule.

20. The network entity of claim 14, wherein the one or more processors are individually or collectively further operable to execute the code to cause the network entity to:
output, via the message, an indication of one or more coefficients associated with a neural network algorithm, wherein the channel-based resource selection procedure corresponds to the neural network algorithm, wherein the set of resources associated with the uplink channel is based at least in part on the one or more coefficients associated with the neural network algorithm.

21. The network entity of claim 20, wherein the one or more processors are individually or collectively further operable to execute the code to cause the network entity to:
obtain a second message indicating one or more second coefficients for the neural network algorithm based at least in part on the indication of the one or more coefficients, at least one of the one or more second coefficients different from the one or more coefficients.

22. The network entity of claim 14, wherein the one or more processors are individually or collectively further operable to execute the code to cause the network entity to:
output, via the message, an indication of an allocation of the set of resources associated with the uplink channel, wherein the channel-based resource selection procedure comprises determining the set of resources in accordance with the allocation.

23. The network entity of claim 22, wherein the one or more processors are individually or collectively further operable to execute the code to cause the network entity to:
output a control message that activates or deactivates the allocation for the set of resources, wherein the control message is received via a medium access control-control element (MAC-CE), a downlink control information (DCI) message, or both.

24. The network entity of claim 14, wherein the channel-based resource selection procedure is further based at least in part on a quantity of user equipments (UEs), a format of the feedback message, a payload size of the feedback message, an allocation configuration, a slot structure, or any combination thereof.

25. The network entity of claim 14, wherein the one or more processors are individually or collectively further operable to execute the code to cause the network entity to:
output, via the message, an indication of a plurality of channel-based resource selection procedures including the channel-based resource selection procedure, wherein the message indicates the channel-based resource selection procedure based at least in part on an index included in the message that corresponds to the channel-based resource selection procedure.

26. The network entity of claim 14, wherein the one or more processors are individually or collectively further operable to execute the code to cause the network entity to:
output an indication of a bandwidth allocation for a user equipment (UE), wherein the set of resources is determined based at least in part on the bandwidth allocation and in accordance with the channel-based resource selection procedure.

27. A method for wireless communications by a user equipment (UE), comprising:
receiving a message indicating a channel-based resource selection procedure for a feedback message, wherein the channel-based resource selection procedure is based at least in part on one or more channel estimates;
receiving a downlink message via a downlink channel; and
transmitting, via a set of resources associated with an uplink channel, the feedback message indicating whether the downlink message was successfully decoded, wherein the set of resources is based at least in part on the one or more channel estimates and in accordance with the channel-based resource selection procedure.

28. The method of claim 27, further comprising:
transmitting a capability message indicating one or more capabilities associated with the channel-based resource selection procedure, wherein the channel-based resource selection procedure indicated via the message is based at least in part on the one or more capabilities.

29. A method for wireless communications by network entity, comprising:
outputting a message indicating a channel-based resource selection procedure for a feedback message, wherein the channel-based resource selection procedure is based at least in part on one or more channel estimates;
outputting a downlink message via a downlink channel; and
obtaining, via a set of resources associated with an uplink channel, the feedback message indicating whether the downlink message was successfully decoded, wherein the set of resources are based at least in part on the channel-based resource selection procedure.

30. The method of claim 29, further comprising:
obtaining a capability message indicating one or more capabilities of a user equipment (UE) associated with the channel-based resource selection procedure, wherein the channel-based resource selection procedure indicated via the message is based at least in part on the one or more capabilities.
